(19) United States
(12) Patent Application Publication
(10) Pub. No.: US 2006/0256042 A1
(43) Pub. Date: Nov. 16, 2006

(54) Plasma display apparatus and driving method thereof

(75) Inventors: Jung Gwan Han, Gyeongsangbuk-do (KR); Katsuo Isono, Tokyo (JP)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/354,154

(22) Filed: Feb. 15, 2006

(30) Foreign Application Priority Data
May 10, 2005 (KR) 10-2005-0038994

(51) Int. Cl. G09G 3/28

(52) U.S. Cl. 345/67

(57) ABSTRACT

The present invention relates to a plasma display apparatus and driving method thereof, wherein application time points of data pulses applied to address electrode groups, where each group includes one or two address electrodes, are controlled. This results in a reduction of noise generation. The benefits of reducing noise include enhancing the driving efficiency of the plasma display panel and preventing electrical damage to driving circuits. The plasma display apparatus includes a plasma display panel including a plurality of address electrodes, a data driving unit that drives the plurality of the address electrodes, and a data pulse controller that controls the data driving unit to make application time points of the data pulses, which are applied to neighboring address electrode groups, to be different from each other.

### CROSS-REFERENCES TO RELATED APPLICATIONS

This Nonprovisional application claims priority under 35 U.S.C. § 119(a) on Patent Application No. 10-2005-0038994 filed in Korea on May 10, 2005, the entire contents of which are hereby incorporated by reference.

### BACKGROUND OF THE INVENTION

1. Field of the Invention

The present invention relates to a plasma display panel, and more particularly; to a plasma display apparatus and driving method thereof, wherein the voltage-rising and/or the voltage-falling application time points of data pulses applied to address electrode groups, where each address electrode group includes at least one address electrode, are controlled to reduce noise generation.

2. Background of the Related Art

Generally, a plasma display panel includes barrier ribs formed between a front substrate and a rear substrate. Together, the barrier ribs, and the front and rear substrates form cells. Each of the cells is filled with a primary discharge gas such as neon (Ne), helium (He) or a mixed gas comprising Ne and He. In addition, each cell contains an inert gas comprising a small amount of xenon. If the inert gas is discharged using a high voltage, vacuum ultraviolet rays are generated. The ultra-violet rays excite light-emitting phosphors formed between the barrier ribs to display an image. Plasma display panels can be made thin and slim, and have thus been in the spotlight as one of the next-generation of display devices.

FIG. 1 is a perspective view illustrating the construction of a related art plasma display panel. As illustrated in FIG. 1, the related art plasma display panel includes a front substrate 100 in which a plurality of pairs of display electrodes, which are formed by a plurality of pairs of scan electrodes 102 and sustain electrodes 103, are arranged on a front glass 101 that serves as a display surface on which the images are displayed. The plasma display panel also includes a rear substrate 110, in which a plurality of address electrodes 113 cross the plurality of the sustain electrodes, is arranged on a rear glass 111 forming a rear surface. The front substrate 100 and the rear substrate 110 are parallel to each other, with a predetermined distance therebetween.

The front substrate 100 includes the pairs of the scan electrodes 102 and the sustain electrodes 103, which perform discharge against the other mutually and maintain emission in one discharge cell. That is, the scan electrode 102 and the sustain electrode 103 each has a transparent electrode “a” made of a transparent ITO material and a bus electrode “b” made of a metal material, and the scan and sustain electrodes 102, 103 are formed in pairs. The scan electrodes 102 and the sustain electrodes 103 are covered with one or more dielectric layers 104 to limit a discharge current and to provide insulation among the electrode pairs. A protection layer 105, on which magnesium oxide (MgO) is deposited in order to facilitate a discharge condition, is formed on the dielectric layer 104.

On the rear substrate 110, barrier ribs 112—of a stripe type or a well type—for forming a plurality of discharge spaces, i.e., discharge cells, are arranged in a parallel manner. Further, a plurality of address electrodes 113, which perform address discharging to generate the vacuum ultraviolet rays, are disposed parallel to the barrier ribs 112. Red (R), green (G) and blue (B) phosphors 114, which emit the visible rays for image display upon address discharging, are coated on a top surface of the rear substrate 110. A low dielectric layer 115 to protect the address electrodes 113 is formed between the address electrodes 113 and the phosphors 114.

A method for implementing image gray scales in this plasma display panel will now be described with reference to FIG. 2. As shown in FIG. 2, in order to represent the gray scales of the image in the related art plasma display panel, one frame period is divided into a plurality of sub-fields having a different number of emissions. Each sub-fields is subdivided into a reset period for initializing all cells, an address period for selecting discharged cells, and a sustain period SPD for implementing gray scales according to the number of discharges. For example, if it is desired to display an image with 256 gray scales, a frame period (16.67 ms) corresponding to 1/60 second is divided into eight sub-fields SF1 to SF8 as shown in FIG. 3. Each of the eight sub-fields SF1 to SF8 is subdivided into the reset, address and sustain periods as indicated above.

The reset period and the address period of each of the sub-fields are the same every sub-field. Address discharge for selecting cells to be discharged is generated due to a voltage difference between the address electrodes 113 and transparent electrodes “a” of the scan electrodes. The sustain period increases in the ratio of 2ⁿ (where, n=0,1,2,3,4,5,6,7) in each of the sub-fields. Because the sustain period is varied in each sub-field, the gray scale of is image is represented by adjusting the sustain period of each of the sub-fields, i.e., by adjusting the number of sustain discharges. A driving waveform in the method of driving the plasma display panel will be below described with reference to FIG. 3.

Referring to FIG. 3, the plasma display panel is driven in the following manner: each sub-field is divided into a reset period for initializing all cells, an address period for selecting cells to be discharged, a sustain period for maintaining discharging of selected cells, and an erase period for erasing wall charges within discharged cells.

The reset period is further divided into a set-up period and a set-down period. In the set-up period, a ramp-up waveform Ramp-up is applied to all scan electrodes 102 simultaneously. A weak dark discharge is generated within discharge cells of the entire screen due to the ramp-up waveform. The set-up discharge causes positive polarity wall charges to be accumulated on the address electrodes 113 and the sustain electrodes 103 and also causes negative polarity wall charges to be accumulated on the scan electrodes 102.

In the set-down period, after the ramp-up waveform Ramp-down is applied to all scan electrodes 102. The ramp-down waveform is such that the voltage applied to the scan electrodes 102 falls from a positive voltage that is below the peak voltage of the ramp-up waveform to a voltage that is below the ground level voltage. The ramp-down waveform applied to the scan electrodes 102 causes a weak erase discharge to occur within cells. As a result, excessive wall charges formed on the scan electrodes 102 are sufficiently erased. The set-down discharge also causes wall charges to remain within the cells uniformly to the degree in which address discharge can be generated.

In the address period, while a negative scan pulse is sequentially applied to the scan electrodes 102, a positive data pulse—synchronized with the negative scan pulse—is applied to the address electrodes 113. As a voltage difference between the scan pulse and the data pulse and a wall voltage generated in the reset period are added, address discharging is generated within discharge cells to which the data pulse is applied. Further, wall charges of the degree in which discharge can be generated when a sustain voltage Vs is applied are formed within cells selected by the address discharging. A positive polarity voltage Vz is applied to the sustain electrodes 103 so that erroneous discharge is not generated with the scan electrode 102 by reducing a voltage difference with the scan electrode 102 during the set-down period and the address period.

In the sustain period, a sustain pulse Sus is alternately applied to the scan electrodes and the sustain electrodes. In cells selected by address discharging, sustain discharge, i.e., a display discharge is generated between the scan electrodes and the sustain electrodes whenever each sustain pulse is applied as the wall voltage within the cells and the sustain pulse are added.

After the sustain discharge is completed, in the erase period, an erase ramp waveform Ramp-ers, which has a narrow pulse width and a low voltage level, is applied to the sustain electrodes 103 so that wall charges remaining in the cells of the entire screen are erased.

In the related art driving waveform, application time points of the data pulses applied to the address electrodes 113 in the address period will be described with reference to FIG. 4. As shown in FIG. 4, in the related art driving waveform, application time points of the data pulses applied to the address electrodes in the address period are the same for all address electrodes. For example, the data pulses to all the address electrodes from an X1 address electrode to an Xm address electrode are applied at a time point ts. The data pulses applied to the address electrodes thus generates address discharges in conjunction with the scans pulse applied to scan electrodes (not shown in FIG. 4).

A discharge cell of the plasma display panel can be represented as a capacitor with a given amount of equivalent capacitance. This will be described with reference to FIG. 5. As illustrated in FIG. 5, in the plasma display panel, one discharge cell is formed at each intersection where the display electrode pair, e.g., the scan electrode Y_{A} and the sustain electrode Z_{A}, which are parallel to each other as shown in FIG. 5, cross the address electrodes X_{A} and X_{B}. In this case, a capacitor with some equivalent capacitance C1 is formed between the address electrode X_{A} and the scan electrode Y_{A}. Further, a capacitor with some equivalent capacitance C2 also is formed between the address electrode X_{A} and the sustain electrode Z_{A}. A capacitor with some equivalent capacitance C3 is formed between the address electrodes X_{A} and the X_{B}. When this plasma display panel is driven, the current flowing through one discharge cell is dependent upon the equivalent capacitance of the discharge cell and the variation ratio of the voltage per unit time. The current can be represented by the following equation 1.
I(current)=C(capacitance)×dV/dt (1)

From the above equation 1, it can be seen that if the applied current is a constant, the variation ratio of the voltage (V) per unit time (t) depends on the equivalent capacitance (C) value. That is, if the capacitance (C) value increases, the variation ratio (dV/dt) of the voltage per unit time decreases. On the other hand, if the capacitance (C) value decreases, the variation ratio (dV/dt) of the voltage per unit time increases. In other words, if the capacitance (C) value is relatively large, the voltage of the data pulse rises or falls at a relatively small tilt, i.e. more gradually. If the capacitance (C) value is relatively small, the voltage of the data pulse rises or falls at a relatively high tilt, i.e. more abruptly.

In the related art, application time points of data pulses of FIG. 4, and a voltage-rising or voltage-falling time of the data pulse will be described with reference to FIG. 6 taking into account the relationship between the capacitance and the variation ratio of the voltage per unit time.

Referring to FIG. 6, in the related art driving waveform, the data pulses rise or fall at a predetermined tilt for all address electrodes. For example, as shown in FIG. 6, the data pulses that are applied to address electrodes X1, X2, X3 . . . Xm all begin rising at a time point t1 reach the highest point at a time point t2. That is, the voltage-rising application time point is t1 for all data pulses, and the voltage-rising time is (t2−t1) for all data pulses as well. Assuming that a difference between the lowest voltage and the highest voltage of the data pulses is V, the rising tilt of the data pulses is V/(t2−t1). Furthermore, the data pulses that are applied to the same address electrodes all begin falling at a time point t3 and reaches the lowest point at a time point t4. That is, the voltage-falling application time point is t3 for all data pulses, and the voltage-falling time is (t4−t3) for all data pulses. Again assuming that the difference between the lowest voltage and the highest voltage of the data pulse is V, the falling tilt of the data pulses is V/(t4−t3).

In the related art device, the data pulses are applied to the address electrodes X_{A} and X_{B} at the same time, i.e. the application time points of the data pulses applied to the address electrodes are all the same. As a result, there is no difference in voltage between the address electrodes.

Referring back to FIG. 5, for each discharge cell circuit, the total equivalent capacitance circuit is C1+C2+C3. However, because there is no voltage differential between the address electrodes X_{A} and X_{B} in the related art device, the effect of the equivalent capacitance C3 is lost. Thus, in the related art, the equivalent capacitance of the discharge circuit becomes C1+C2 owning to the voltage differences between the address electrode X_{A} and the scan electrode Y_{A} and between the address electrode X_{A} and the sustain electrode Z_{A}. In other words, where the application time points of the data pulses applied to all address electrodes are the same, the total capacitance generated by the data pulses applied to the address electrodes is C1+C2.

Accordingly, if the application time points of the data pulses of all the address electrodes are the same as shown in FIG. 4, a value of capacitance generated by the data pulses applied to each address electrode is relatively small (C1+C2). As a result, the voltage variation ratio per unit time of the data pulse becomes relatively large. To state it another way, the voltage rising and/or falling tilts are abrupt. As shown in FIG. 6, the rising tilt V/(t2−t1) of the data pulses applied to the address electrodes X1, X2, X3, . . . XM is relatively abrupt. Furthermore, the falling tilt V/(t4−t3) of the data pulses is also relatively abrupt. In other words, the voltage-rising time and the voltage-falling time of the data pulse are relatively short. For example, the voltage-rising time and the voltage-falling time of this related art data pulse is short, approximately 20 ns.

Due to the relatively short voltage-rising and voltage-falling times, a significant amount of noise is generated in the related art device. Noise generation in the data pulses of the related art will be described with reference to FIG. 7. As illustrated in FIG. 7, it can be seen that relatively high noise is generated in the data pulse applied to each address electrode. That is, a given amount of noise is generated in both the voltage rising and falling directions of the data pulses. This noise is generated due to coupling of the data pulses applied to the address electrodes at points where the voltage of the data pulse abruptly changes in both the rising and falling directions. In the related art, since the voltage-rising time and the voltage-falling time of the data pulses are relatively short as illustrated in FIG. 6, variations at the points where the voltage abruptly changes further increases. This further increases noise.

Furthermore, if the application time points of data pulses applied to all address electrodes are the same, voltages of data pulses of neighboring two address electrodes also change when the voltage of the data pulse of one address electrode changes. This also leads to further increased noise.

If the difference between the highest value of rising noise and the lowest value of falling noise, i.e., the amount of total noise Vr is greater than some threshold, the address discharge generation in the address period becomes unstable, which reduces the driving efficiency of the plasma display panel. Also, electrical damage to data drive ICs used to apply the data pulses to the address electrodes can occur. Components having high rating voltages can be used to prevent such electrical damage to the data drive ICs. However, utilizing such components increases the cost of production.

### SUMMARY OF THE INVENTION

Accordingly, an embodiment of the present invention provides a plasma display apparatus and method of driving the same, wherein the voltage-rising time and the voltage-falling time of data pulses is changed by controlling the voltage-rising and/or the voltage-falling application time points of data pulses to reduce noise generation.

According to an embodiment of the present invention, a plasma display panel of a plasma display display includes a plurality of address electrodes, a data driving unit that drives the plurality of the address electrodes, and a data pulse controller that controls the data driving unit so that the application time points of data pulses applied to neighboring address electrode groups of a plurality of address groups, where each group includes one or more address electrodes, to be different from each other.

Furthermore, the data pulse controller controls the number of the address electrode groups to be within a range between 2 and the total number of the address electrodes.

Furthermore, the data pulse controller controls application time points of data pulses applied to the plurality of the address electrodes to be the same within each address electrode group.

Furthermore, the data pulse controller controls the plurality of the address electrode groups to have one, two or more address electrodes, respectively.

Furthermore, the data pulse controller controls the application time points of the data pulses applied to odd-numbered address electrode groups of the plurality of the address electrode groups to be the same, controls the application time points of the data pulses applied to even-numbered address electrode groups of the plurality of the address electrode groups to be the same, and controls application time points of data pulses applied to the odd-numbered address electrode groups and the even-numbered address electrode groups to be different from each other.

Furthermore, the data pulse controller controls each of the plurality of the address electrode groups to have one address electrode, controls the application time points of data pulses applied to odd-numbered address electrodes of the plurality of the address electrodes to be the same and controls the application time points of data pulses applied to even-numbered address electrodes of the plurality of the address electrodes to be the same, and controls the application time points of data pulses applied to the odd-numbered address electrodes and the even-numbered address electrodes to be different from each other.

Furthermore, the data pulse controller controls the application time points of the data pulses applied to the plurality of the address electrode groups to have at least three or more different values.

Furthermore, the data pulse controller controls at least one of the three or more different application time points of the data pulses to be periodically repeated at least twice.

Furthermore, the data pulse controller controls at least two or more of the three or more different application time points of the data pulses to be periodically repeated at least twice, and controls the repetition cycles thereof to be the same.

Furthermore, the data pulse controller controls the intervals between the application time points of the data pulses having different application time points to be substantially regular.

Furthermore, the data pulse controller controls an interval between the application time points between two data pulses having different application time points, among the data pulses applied to the plurality of the address electrode groups, to range substantially between 10 ns and 120 ns.

Furthermore, the data pulse controller controls one of the voltage-rising time and/or the voltage-falling time of the data pulses applied to the plurality of the address electrode groups to range substantially between 100 ns and 200 ns.

Furthermore, the data driving unit includes a plurality of channels, and a plurality of data drive ICs electrically connected to the plurality of the address electrodes through the channels. The data pulse controller controls the application time points of the data pulses applied to the address electrodes respectively connected to a plurality of channels of one of the data drive ICs to be the same.

Furthermore, the data driving unit includes a plurality of channels, and a plurality of data drive ICs electrically connected to the plurality of the address electrodes through the channels. The data pulse controller controls the application time points of data pulses, which are applied to the address electrodes respectively connected to neighboring two of a plurality of channel groups, where each channel group includes one or more of the channels, to be different from each other in one or more of the plurality of the data drive ICs.

Furthermore, each of the data drive IC includes a latch unit, which has the plurality of the channels, and latches externally provided picture data and supplies the latched picture data to the address electrodes, each connected to the plurality of the channels, and a data delay unit that applies a control signal or signals to the latch unit, wherein the control signal(s) causes the application time points of data pulses, which are applied to the address electrodes respectively connected to neighboring two channels of a plurality of channel groups, to be different from each other.

Furthermore, the data delay unit applies a control signal or signals to the latch unit. In this case, the control signal(s) causes the application time points of data pulses applied to the address electrodes connected to odd-numbered channel groups including odd-numbered channels among the plurality of the channels connected to the latch unit to be the same, controls the application time points of data pulses applied to the address electrodes connected to even-numbered channel groups including even-numbered channels among the plurality of the channels connected to the latch unit to be the same, and the controls application time points of data pulses applied to address electrodes connected to the odd-numbered channel groups and the address electrodes connected to the even-numbered channel groups including the even-numbered channels to be different from each other.

Furthermore, the data delay unit applies a control signal(s) to the latch unit. In this case, the control signal(s) causes an interval between application time points of the data pulses applied to the address electrodes connected to the odd-numbered channel groups including the odd-numbered channels among the plurality of the channels connected to the latch unit and the address electrodes connected to the even-numbered channel groups including the even-numbered channels among the plurality of the channels connected to the latch unit to range substantially between 10 ns and 120 ns.

Furthermore, the data delay unit applies three or more different control signals, which cause the application time points of the data pulses to have three or more different values, to the latch unit.

Furthermore, the number of the channels included in each of the data drive ICs is 150 or greater.

According to an embodiment of the present invention, in a method of driving a plasma display panel including a plurality of address electrodes, the application time points of data pulses, which are applied to neighboring two of a plurality of address electrode groups including one or more of the address electrodes through a plurality of channels of a plurality of data drive ICs, are different from each other.

Furthermore, the number of the address electrode groups ranges from 2 to a total number of the address electrodes.

Furthermore, the application time points of data pulses applied to the plurality of the address electrodes are the same within each electrode group of the plurality of the address electrodes divided among the plurality of the address electrode groups.

Furthermore, each of the plurality of the address electrode groups has one, two or more address electrodes, respectively.

Furthermore, the application time points of data pulses applied to odd-numbered address electrode groups of the plurality of the address electrode groups are the same, the application time points of data pulses applied to even-numbered address electrode groups of the plurality of the address electrode groups are the same, but the application time points of data pulses applied to the odd-numbered address electrode groups and the even-numbered address electrode groups are different from each other.

Furthermore, each of the plurality of the address electrode groups has one address electrode, the application time points of data pulses applied to odd-numbered address electrodes of the plurality of the address electrodes are the same, the application time points of data pulses applied to even-numbered address electrodes of the plurality of the address electrodes are the same, but the application time points of data pulses applied to the odd-numbered address electrodes and the even-numbered address electrodes are different from each other.

Furthermore, the application time points of the data pulses applied to the plurality of the address electrode groups have at least three or more different values.

Furthermore, at least one of the three or more different application time points of the data pulses are periodically repeated at least twice.

Furthermore, at least two or more of the three or more different application time points of the data pulses are periodically repeated at least twice, and the repetition cycles thereof are the same.

Furthermore, a difference in the application time point between two data pulses having different application time points are the same.

Furthermore, an interval between the application time points of two data pulses having different application time points, among the data pulses applied to the plurality of the address electrode groups, ranges substantially from 10 ns to 120 ns.

Furthermore, the voltage-rising time and/or the voltage-falling time of the data pulses applied to the plurality of the address electrode groups ranges substantially from 100 ns to 200 ns.

Furthermore, the application time points of data pulses applied to the address electrodes respectively connected to a plurality of channels of one of the data drive ICs are the same.

Furthermore, the application time points of data pulses, which are applied to the address electrodes respectively connected to neighboring two of a plurality of channel groups including one or more of the channels, are different from each other in one or more of the plurality of the data drive ICs.

Furthermore, the number of the channels included in each of the data drive ICs is 150 or greater.

### BRIEF DESCRIPTION OF THE DRAWINGS

Further objects and advantages of the invention can be more fully understood from the following detailed description taken in conjunction with the accompanying drawings in which:

FIG. 1 is a perspective view illustrating the construction of a related art plasma display panel;

FIG. 2 is a view for explaining a method for implementing image gray scales in the related art plasma display panel;

FIG. 3 is a view showing a driving waveform in the method of driving the related art plasma display panel;

FIG. 4 is a view for explaining application time points of data pulses applied to address electrodes in the address period of the related art driving waveform;

FIG. 5 is an equivalent circuit diagram of a discharge cell of a plasma display panel;

FIG. 6 is a view for explaining the voltage-rising times and the voltage-falling times of data pulses applied to the address electrodes in the address period in the related art driving waveform;

FIG. 7 is a view for explaining noise generation due to data pulses applied to address electrodes in the address period in the related art driving waveform;

FIG. 8 is a view showing the construction of a plasma display apparatus according to an embodiment of the present invention;

FIGS. 9a and 9b are views showing a grouping of address electrodes for explaining exemplary methods of dividing a plurality of address electrodes into a plurality of address electrode groups according to embodiments of the present invention;

FIG. 10 is a view for explaining a method of driving a plasma display panel according to an embodiment of the present invention;

FIG. 11 is a view for explaining voltage-rising times and voltage-falling times of data pulses applied to each address electrode group in the address period of the driving waveform according to an embodiment of the present invention;

FIG. 12 is a view for explaining noise generated due to the data pulses applied to the address electrodes in the address period of the driving waveform according to an embodiment of the present invention;

FIG. 13 is a view for explaining a case where each address electrode group has a single address electrode according to an embodiment of the present invention;

FIG. 14 is a view for explaining a method of setting application time points of data pulses applied to every address electrode according to an embodiment of the present invention;

FIG. 15 is a view for explaining a method in which application time points of data pulses have at least three or more different values according to an embodiment of the present invention;

FIG. 16 is a view for explaining a case where data pulses having three or more different values are randomly repeated according to an embodiment of the present invention;

FIG. 17 is a view for explaining an example that a difference in application time points between two data pulses having different application time points is different in an embodiment of the present invention;

FIGS. 18a, 18b and 18c are views for explaining exemplary embodiments of data drive ICs, each including a plurality of channels, and a method in which the plurality of the channels are divided into a plurality of channel groups, each channel group having one or more channels, according to an embodiment of the present invention;

FIG. 19 is a block diagram showing a structure of a data drive IC of a plasma display apparatus according to an embodiment of the present invention;

FIG. 20 is a view for explaining an exemplary operation of a data delay unit for controlling the application time points of the data pulses within the channel group of the data drive IC according to an embodiment of the present invention;

FIG. 21 is a block diagram showing another structure of a data drive IC of the plasma display apparatus according to an embodiment of the present invention;

FIG. 22 is a view for explaining another exemplary operation of the data delay unit for controlling the application time point of the data pulse within the channel group of the data drive IC; and

FIG. 23 is a view for explaining an exemplary method in which different control signals are applied to one data drive IC through different strobes to control the application time point of the data pulses of every channel group within one data drive IC.

### DETAILED DESCRIPTION OF THE PREFERRED EMBODIMENT

Hereinafter, apparatuses and methods for driving plasma display panel according to the present invention will be described in detail in connection with preferred embodiments with reference to the accompanying drawings.

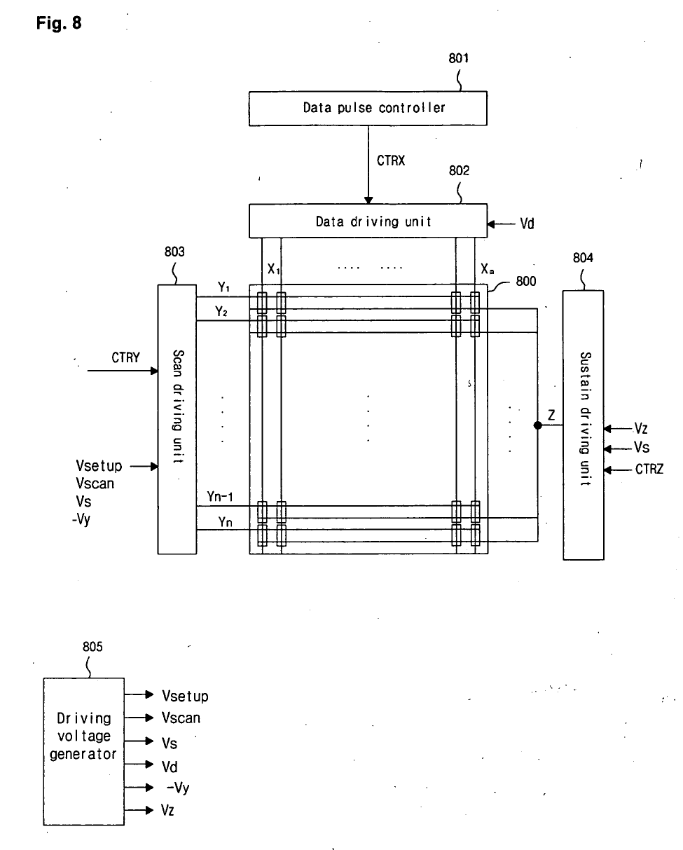

FIG. 8 is a view showing the construction of a plasma display apparatus according to an embodiment of the present invention. In FIG. 8, the plasma display apparatus includes a plasma display panel 800 including scan electrodes Y1 to Yn, a sustain electrode Z, and a plurality of address electrodes X1 to Xm crossing the scan electrodes Y1 to Yn and the sustain electrode Z. The sustain electrode Z can be implemented as a common electrode. The plasma display panel 800 displays an image through applying driving pulses to the address electrodes X1 to Xm, to the scan electrodes Y1 to Yn and to the sustain electrode Z in the reset, address and sustain periods of a sub-field. The plasma display apparatus also includes a data driving unit 802 that applies data pulses to the address electrodes X1 to Xm, a scan driving unit 803 that drives the scan electrodes Y1 to Yn, a sustain driving unit 804 that drives the sustain electrode Z, a data pulse controller 801 that controls the data driving unit 802, and a driving voltage generator 805 that supplies necessary driving voltages to the driving units 802, 803 and 804.

This plasma display apparatus displays image frames through a combination of at least one or more subfields where the driving pulses are applied to the address electrodes X1 to Xm, the scan electrodes Y1 to Yn or the sustain electrode Z in the reset, address and sustain periods. In the present embodiment, in the subfields of the frames, application time points of the data pulses applied to the plurality of the address electrodes X1 to Xm during the address period are controlled by controlling the data driving unit 802. The reason why the application time points of the data pulse is controlled will be explained below.

The aforementioned plasma display panel 800 includes a front panel (not shown) and a rear panel (not shown), which are combined together with a predetermined distance therebetween. Each of the scan electrodes Y1 to Yn is paired with the sustain electrode Z. The scan electrodes Y1 to Yn and the sustain electrode Z cross the address electrodes X1 to Xm.

Image data, which undergo inverse gamma correction and error diffusion through an inverse gamma correction circuit (not shown), an error diffusion circuit (not shown), etc. and mapped to respective subfields by means of a subfield mapping circuit (now shown), are provided to the data driving unit 802. The data driving unit 802 includes a plurality of data drive ICs having a plurality of channels electrically connected to the address electrodes X1 to Xm. The data driving unit 802 applies data pulses to the address electrodes X1 to Xm through the channels of the data drive ICs. The data driving unit 802 samples and latches the data in response to a data timing control signal CTRX from the data pulse controller 801 and applies the data pulses to the address electrodes X1 to Xm.

The scan driving unit 803 supplies a ramp-up waveform Ramp-up and a ramp-down waveform Ramp-down to the scan electrodes Y1 to Yn during the reset period. Furthermore, the scan driving unit 803 sequentially supplies a scan pulse Sp of a voltage −Vy to the scan electrodes Y1 to Yn during the address period, and applies the sustain pulse Sus to the scan electrodes Y1 to Yn during the sustain period.

The sustain driving unit 804 supplies a sustain voltage Vs to the sustain electrode Z during the reset period and a bias voltage Vz during the address period under the control of the timing controller (not shown). The sustain driving unit 804 also supplies the sustain pulse Sus to the sustain electrode Z alternating with the scan driving unit 803 during the sustain period.

The data pulse controller 801 generates and provides control signals to the data driving unit 802 for controlling synchronization in the reset period, the address period and the sustain period. The data pulse controller 801 controls the data driving unit 802 by providing the timing control signal CTRX to the data driving unit 802. More particularly, the data pulse controller 801 controls the aforementioned data driving unit 802 such that the voltage-rising and/or the voltage-falling application time points of data pulses applied to neighboring address electrode groups to be different from each other. Each address group may include one or two address electrodes. The concept of address electrode groups, and the operation and function of the data pulse controller 801 to control the application time points of the data pulses applied to neighboring two address electrode groups to be different from each other will be described in detail below.

The timing control signal CTRX includes a sampling clock for sampling data, a latch control signal, and a switch control signal for controlling on/off time of an energy recovery circuit and a driving switch element (not shown).

The driving voltage generator 805 generates the set-up voltage Vsetup, the scan reference voltage Vsc, the scan voltage −Vy, the sustain voltage Vs, the bias voltage Vz, the data voltage Vd and the like. These driving voltages may vary depending upon the composition of the discharge gas or the structure of a discharge cell.

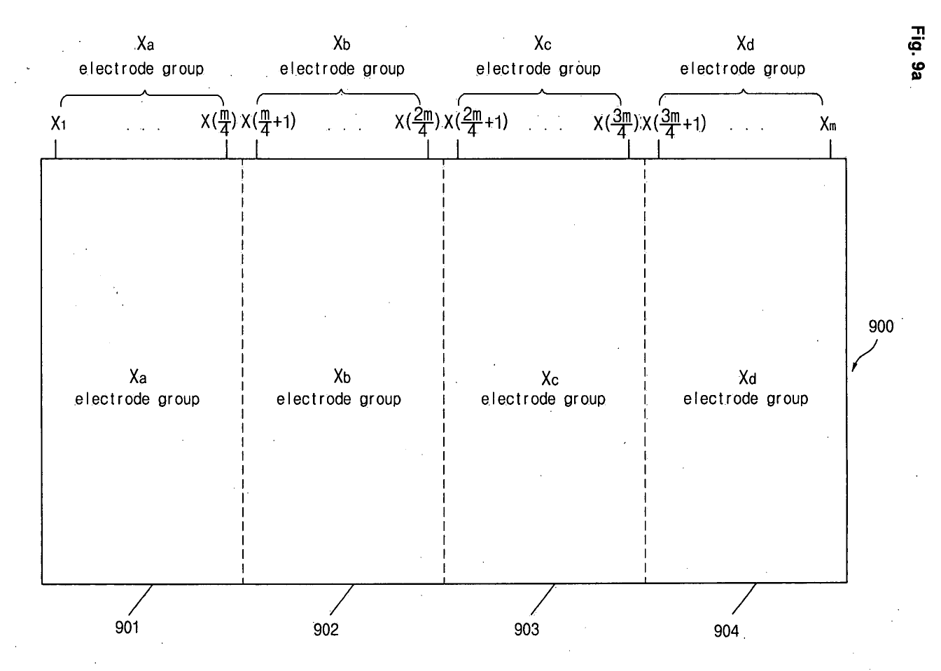

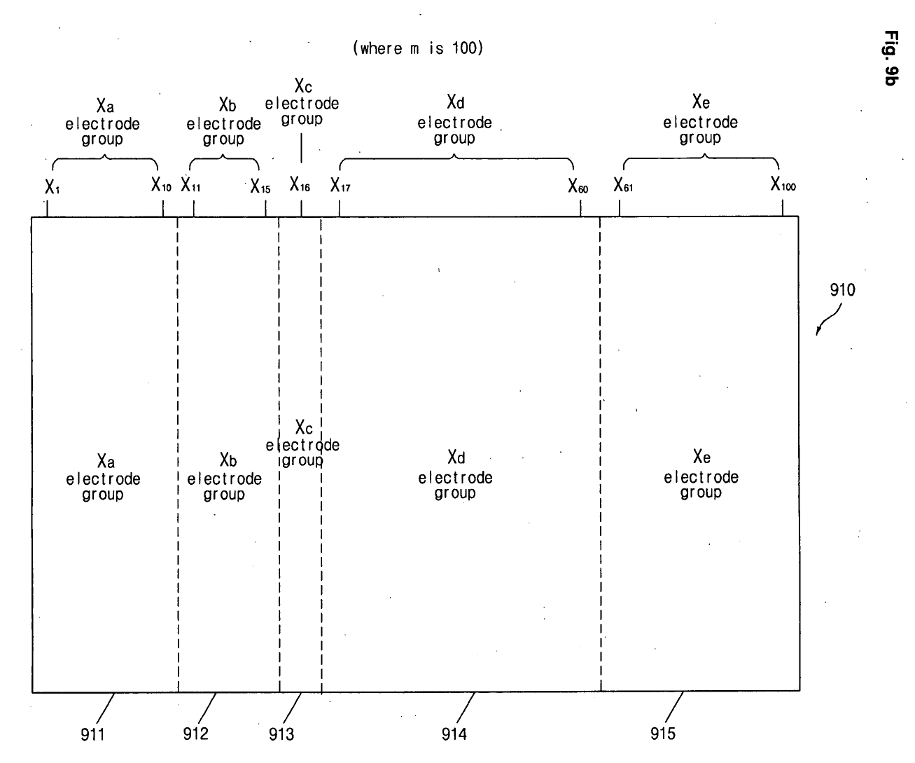

Before a method of driving the plasma display apparatus according to the embodiment of the present invention is described, the address electrode group concept will be first described with reference to FIGS. 9a and 9b in order to facilitate understanding of the method of driving the plasma display panel.

As illustrated in FIG. 9a, address electrodes X1 to Xm formed in the plasma display panel 900 are divided into four address electrode groups Xa (for electrodes X1 to X(m/4)) 901, Xb (for electrodes X((m/4)+1) to X(2 m/4)) 902, Xc (for electrodes X((2 m/4)+1) to X(3 m/4)) 903 and Xd (for electrodes X((3 m/4)+1) to Xm) 904. The number of the address electrode groups ranges from 2 to the total number of address electrodes, i.e., 2≦N≦m, where the total number of address electrodes is m.

In FIG. 9a, for simplicity of explanation, the number of the address electrodes included in each of the address electrode groups 901, 902, 903 and 904 is illustrated as being equal. However, the invention is not so limited. In other words, the number of the address electrodes included in each of the address electrode groups 901, 902, 903 and 904 can be different from each other, i.e. can be arbitrary. The number of the address electrode groups can also be controlled. An example where a different number of address electrodes belong to different address groups will be described with reference to FIG. 9b.

As shown in FIG. 9b, again for illustration purposes only, it is assumed that the total number of the address electrodes of the plasma display panel 910 is 100 and that the address electrodes X1 to X100 are divided address groups Xa, Xb, Xc, Xd and Xe. The address electrodes X1 to X10 belong to the group Xa 911, electrodes X11 to X15 belong to the group Xb 912, electrode X16 belongs to the group Xc 913, electrodes X17 to X60 belong to the group Xd 914, and electrodes X61 to X100 belong to the group Xe 915. In other words, each of the address electrode groups includes a different number of the address electrodes. It should be noted that an address group can include only one electrode. This is illustrated in FIG. 9b with the Xc address electrode group 913 that has the X16 address electrode as the only address electrode in the group.

While it is possible to have a different number of addresses for each address group as illustrated in FIG. 9b, it is also possible that two or more groups have the same number of address electrodes with each other. It may even be preferred that a degree of differences be limited. For example, it may be preferred to set the number of electrodes for groups Xa and Xb to ten each and set the number of electrodes for other groups to twenty each.

For each group of address electrodes, it is preferred that voltage-rising and/or the voltage-falling application time points of the data pulses applied to the address electrodes of each group be substantially the same. For example, the address electrodes X1 to X10 belonging to the group Xa in FIG. 9b may be all be applied with the same data pulse.

This can be accomplished by controlling the data drive ICs to deliver data pulses with same application time points to the address electrodes for each group. As indicated above, the data driving unit may include a plurality of the data drive ICs that are electrically connected to the address electrodes of the display panel. Each data drive IC includes a plurality of channels that serves as paths through which the data pulses are applied to the address electrodes. To this end, it is preferred that one control signal, which controls application time points of data pulses to be the same, is applied to the plurality of the data drive ICs.

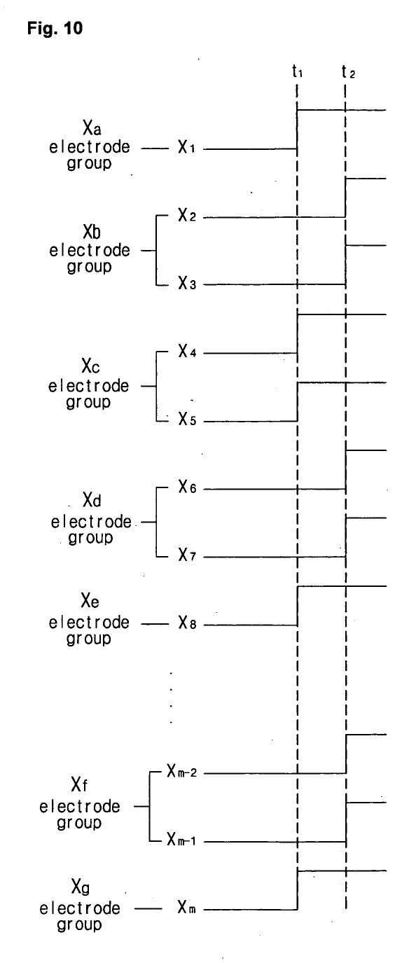

In a method of driving the plasma display panel according to an embodiment of the present invention where the plurality of the address electrodes are divided into the address electrode group as shown in FIGS. 9a and 9b, the application time points of the data pulses applied to neighboring address electrode groups are different from each other. More preferably, where each of the address electrode groups includes one or two address electrodes, application time points of data pulses applied to the neighboring address electrode groups including one or two address electrodes are different from each other. This will be below described with reference to FIG. 10. In FIG. 10, only the voltage-rising application time points are illustrated for ease of explanation. However, it is to be noted that similar principles apply for the voltage-falling application time points. Also for simplicity, the rising tilts of the data pulses are illustrated as being vertical. But it should be noted that the tilts are not necessarily so abrupt.

Referring to FIG. 10, the application time points of data pulses applied to neighboring electrode groups among the plurality of address electrode groups are different from each other. In this example, each electrode group includes one or two electrodes. The application time points of the data pulses applied between any two neighboring address electrode groups are different from each other.

For example, as shown in FIG. 10, the application time point of the data pulse applied to the Xa address electrode group (which includes the X1 address electrode) is t1, the application time point of the data pulse applied to the Xb group (which includes the X2 and X3 address electrodes) is t2, i.e. is different from the application time point t1 of the neighboring group Xa. Similarly, the application time point t2 of the data pulse applied to the Xb is also different from the application time point t1 of the data pulse applied to the other neighboring group Xc (which includes address electrodes X4 and X5. In this manner, the application time point of the data pulse applied to each address electrode group is set to be different from that of the neighboring address electrode groups.

Note that within each group, the application time points of the data pulses applied to the address electrodes of the group is set to be the same. For example, as shown in FIG. 10, the data pulses applied to the X2 and X3 address electrodes of the Xb address electrode group have the same application time point, namely t2.

As illustrated in FIG. 10, the application time points of the data pulses applied to odd-numbered address electrode groups (Xa, Xc, Xe, etc.) are all the same and the application time points of the data pulses applied to even-numbered address electrode groups (Xb, Xd, etc.) thereof are all the same, but the application time points of the data pulses applied to the oddand the even groups are different from each other. With such configuration, application time point of the data pulses applied to neighboring address electrode groups being different can be ensured. Also, this configuration allows for a relatively simple control of the driving circuit, which is an advantage.

It is preferred to have application time points of the data pulse applied to each address electrode be different from the pulse applied to at least one neighboring address electrode. This is illustrated in FIG. 10. For example, the data pulse applied to electrode X1 is different from the pulse applied to electrode X2, the data pulse applied to electrode X3 is different from the pulse applied to electrode X4, and so on. By controlling the application time points of the data pulses as such, the variation ratio of voltage per unit time of the data pulse, i.e., the voltage-rising time and the voltage-falling time increase. The reason will be below described.

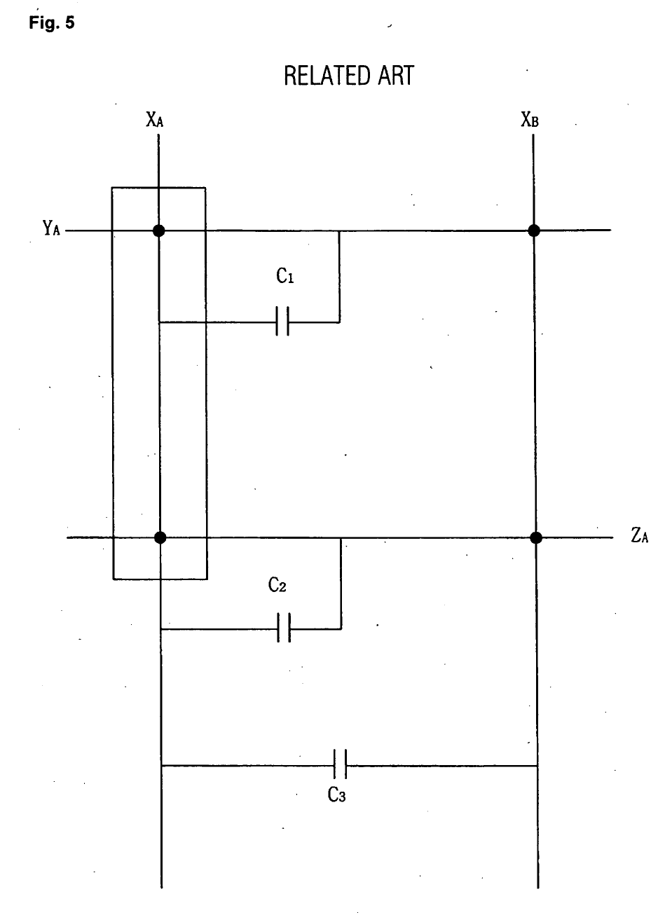

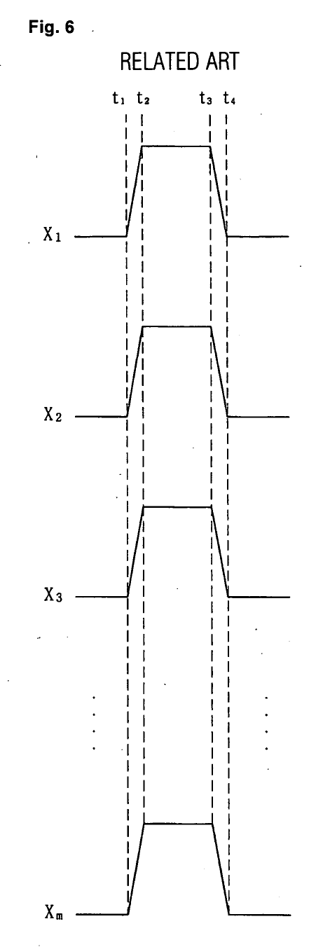

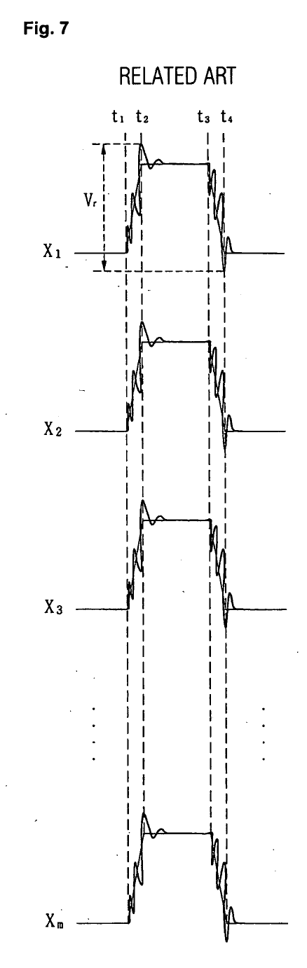

In FIG. 10, it is assumed that the address electrodes X1 and X2 are immediate neighbors of each other. Then referring back to the equivalent circuit as illustrated in FIG. 5, it is seen that the effect of the equivalent capacitance C3 between the neighboring address electrodes X1 and X2 is not lost, which is unlike the situation with the related art. Thus the total capacitance, which is generated by the data pulses applied to the X1 the X2 address electrodes, is C1+C2+C3, which is higher than that of the related art. Then according to the equation 1, if the application time points of the data pulses are controlled as in FIG. 10, the voltage variation ratio per unit time of a data pulse is less than the related art, i.e. the voltage change is more gradual. In other words, the voltage-rising and/or the voltage-falling times are longer than the related art.

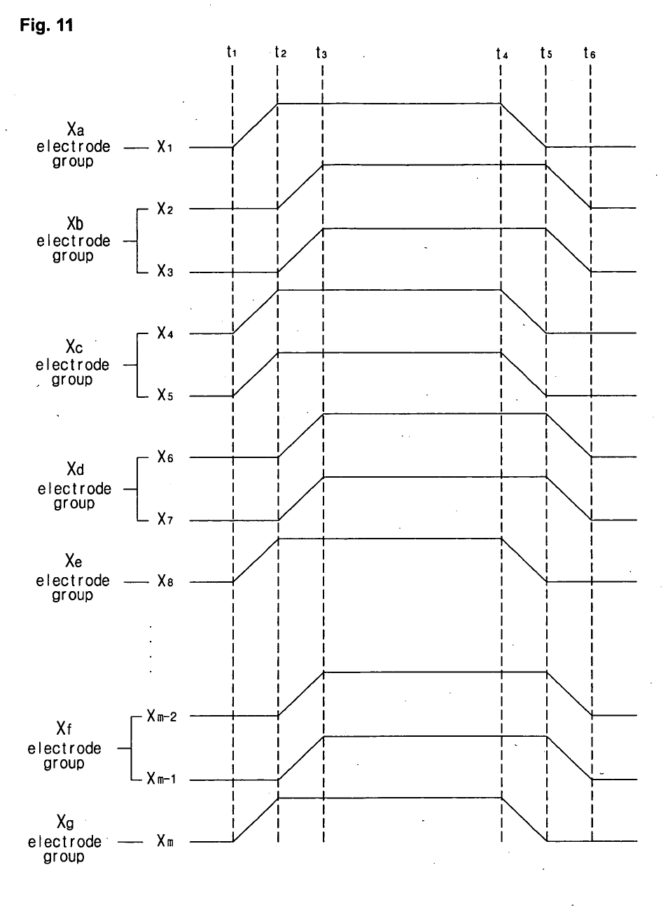

FIG. 11 is a view for explaining the voltage-rising time and the voltage-falling time of the data pulse applied to each address electrode group in the address period of the driving waveform according to an embodiment of the present invention. In FIG. 11, data pulses rise and fall with some tilt for all of the address electrodes. For example, as shown in FIG. 11, the data pulse applied to the Xa address electrode group (to the X1 address electrode) begins rising at the time point t1 and then reaches the highest point at the time point t2. That is, the voltage-rising time of the data pulse is (t2−t1). The data pulses applied to the Xb address electrode group (to the X2 and X3 address electrodes) begin rising at the time point t2 and then reach the highest point at the time point t3, i.e., the voltage-rising time of the data pulse is (t3−t2). The voltage rising time of the data pulses applied to the Xc address electrode is also (t2−t1). In short, the voltage rising times of the address groups alternate between (t2−t1) and (t3−t2). As a result, the voltage-rising time of the data pulses applied to each of the address electrode groups is longer than that of the related art due to the increase in total equivalent capacitance due to a difference between application time points of the data pulses.

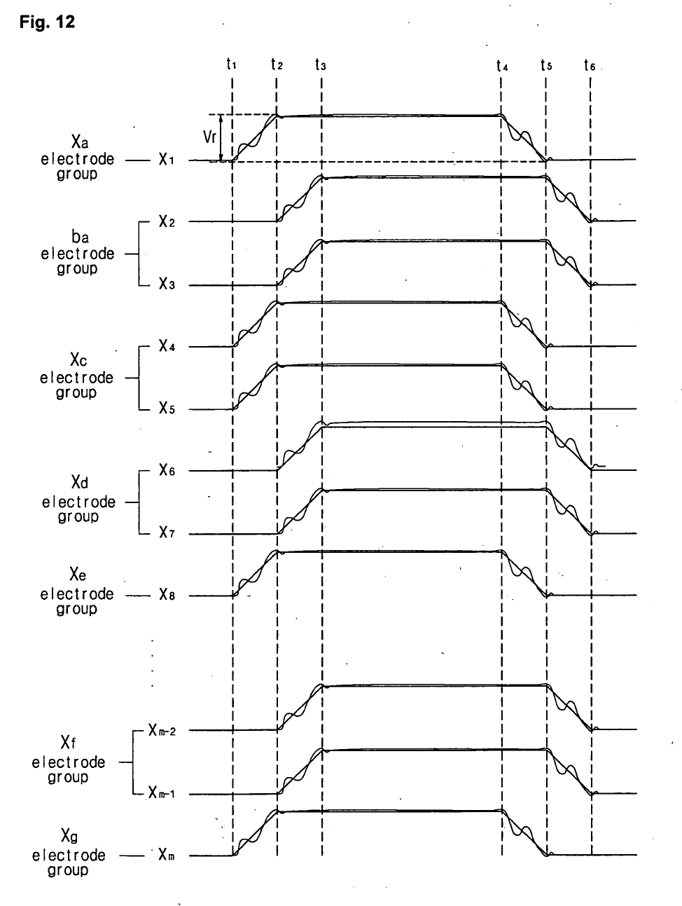

Furthermore, in FIG. 11, it is seen that the voltage-falling times of the data pulses also alternate, namely between (t5−t4) and (t6−t5). Because the pulse falling transition start time points, i.e. the voltage-falling application time points, differ, the voltage-falling times of the data pulses applied to each address electrode is longer than that of the related art again due to the increase in the total equivalent capacitance. Because the voltage-rising times and/or the voltage-falling times of the data pulses applied to the address electrode groups as such are increased compared to the related art, the amount of noise generated is also reduced as illustrated in FIG. 12.

From FIG. 12, it can be seen that the amount of noise generated in the data pulse applied to each of the address electrode groups is significantly reduced. The amount of noise is reduced in both the rising and the falling directions of the data pulse. When the application time points of the data pulses applied to the address electrodes differ (the rising start point and/or the falling start point), the mutual coupling phenomenon between the data pulses is weakend resulting in the reduction of the noise.

Furthermore, the instant variation amount of the data pulse is reduced at a point where the voltage of one data pulse varies and the voltage of the data pulse of at least one neighboring address electrodes is fixed. For example, regarding the X4 address electrode shown in FIG. 11, the data pulse applied to the X3 address electrode is sustained at a constant level, such as the ground level, at the time point where the voltage of the data pulse applied to the X4 address electrode begins rising, i.e. at the time point t1. This further reduces the generation of noise.

Accordingly, as the difference between the highest value of rising noise and the lowest value of falling noise, i.e., the amount of total noise Vr reduces, the address discharge generation in the address period is stabilized to enhance the driving efficiency of the plasma display panel. This also prevents or minimizes the data drive IC from electrical damage.

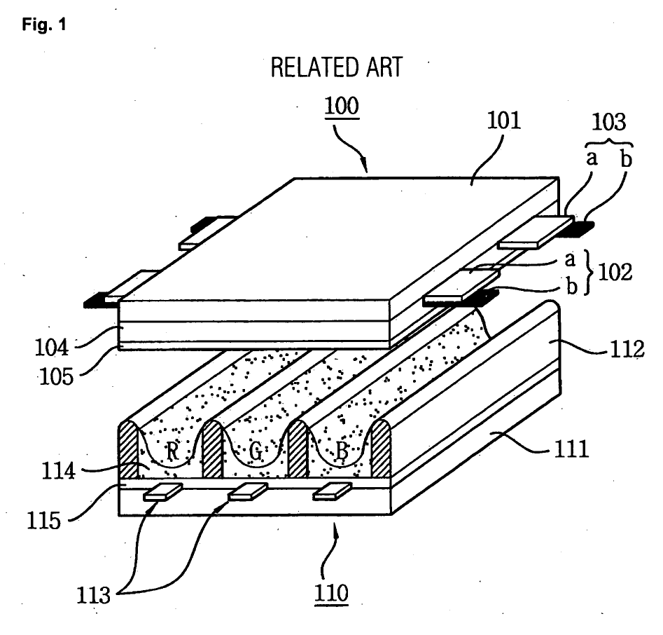

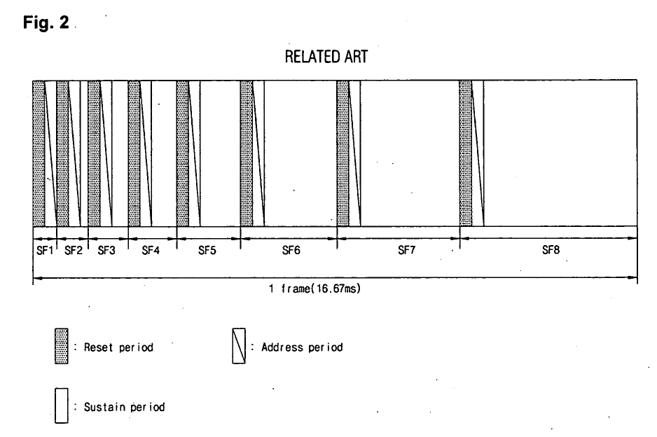

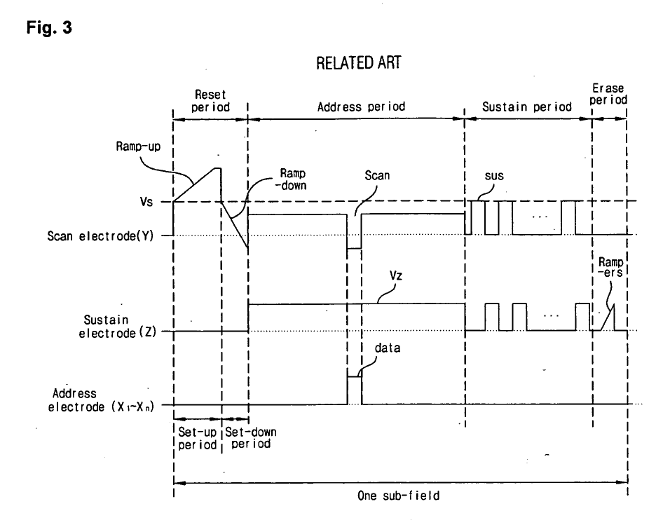

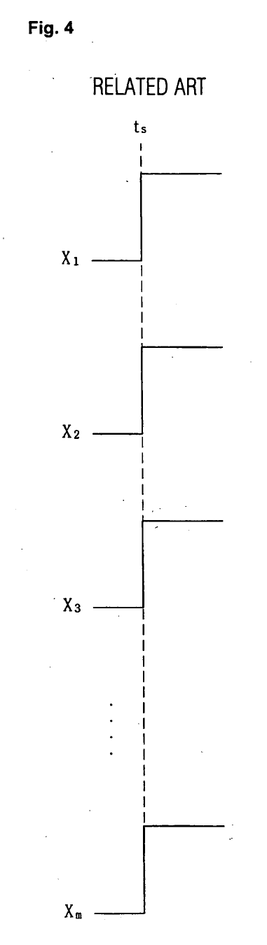

Referring back to FIG. 5, it is noted that the effect of the equivalent capacitance C3 is maximized when the voltage difference between adjacent address electrodes is also maximized. Thus, it is preferred to an interval between the application time points of the data pulses applied to adjacent electrodes be substantially equal to or greater than the voltage-rising and/or the voltage-falling times of the data pulses. Referring to FIG. 1 as an example, the interval between the voltage-rising application time points of the data pulses applied to the X1 and X2 address electrodes (t2−t1) is preferred to be at least as long as the voltage-rising time (again t2−t1) of the X1 address electrode.

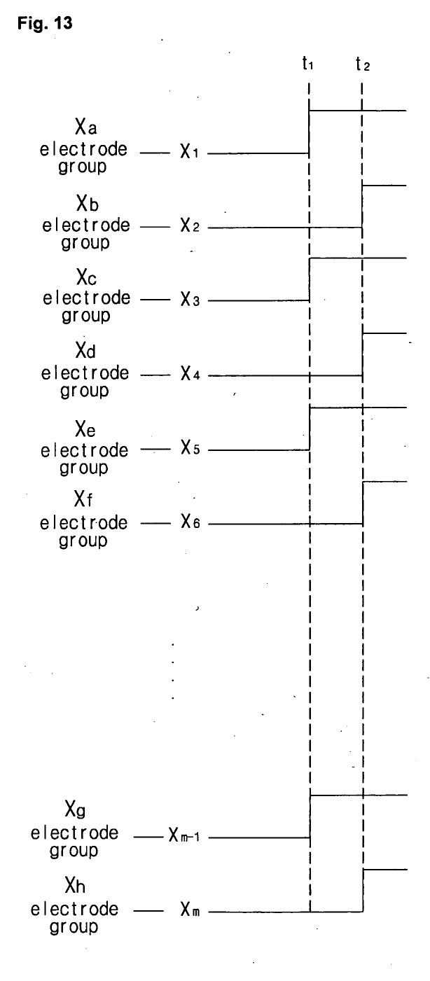

In the above description, a method in which the plurality of the address electrodes are driven with the electrodes being divided into the address electrode groups where each group includes one or two address electrodes is described. It is, however, to be understood that application time points of data pulses applied to each address electrode can be controlled individually. In other words, each of the address electrode groups can be driven with it including one address electrode, i.e. each address electrode is a separate group. This driving method is shown in FIG. 13. Again for simplicity, only the voltage-rising application time points are illustrated and the rising transitions are illustrated as being vertical.

As shown in FIG. 13, each of the plurality of address electrode groups includes only one address electrode. For example, as shown in FIG. 13, the Xa address electrode group includes only the X1 electrode, the Xb address electrode group includes only the X2 address electrode, and so on. The data pulse applied to one address electrode is different from the data pulses applied to both neighboring address electrodes. In FIG. 13, the application time points of data pulses applied to the odd-numbered address electrodes are all substantially the same, namely at t1. The application time points of the data pulses applied to even-numbered address electrodes are also all substantially the same, namely at t2. However, the application time points of data pulses applied to the odd-numbered address electrodes are different from the application time points of the data pulses applied to the even-numbered address electrodes.

As such, when the application time points of the data pulse applied to one address electrodes is different from the application time points of the data pulses of both neighboring addresses electrodes for all electrodes, the equivalent capacitance of the entire plasma display panel is maximized. As a result, the variation ratio of voltage per unit time in accordance with the equation 1 becomes the lowest. In other words, the voltage-rising time and the voltage-falling time of the data pulses become the longest, i.e. less abrupt. Accordingly, the amount of noise Vr is reduced to the maximum extent. Furthermore, at the time points where the data pulses begin rising or falling in the address electrodes, data pulses applied to neighboring two address electrodes are fixed. This results in further reduction in generation of noise.

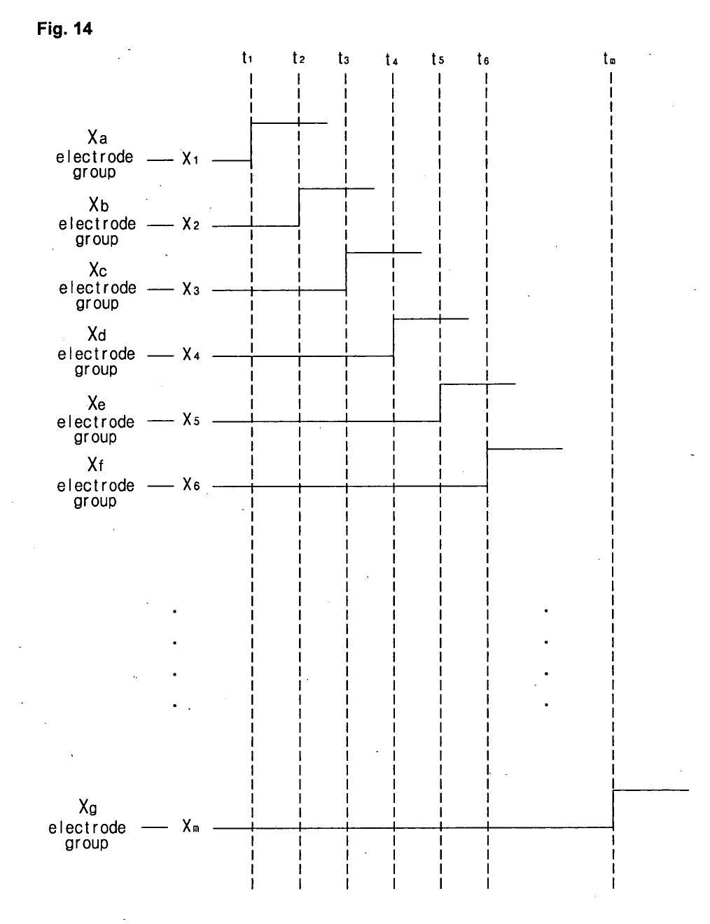

The situation is described above where the plurality of address electrodes are divided into the plurality of address electrode groups and the application time points of the data pulses of odd-numbered electrode groups and even-numbered electrode groups are different from each other, i.e., the application time points of the data pulses are set to different two values. It is, however, to be understood that application time points of data pulses can be set to be different for every address electrode. This method will be described with reference to FIG. 14. Again for simplicity, only the voltage-rising application time points are illustrated and the rising transitions are illustrated as being vertical. But as indicated before, the principles can be expanded to cover the voltage-falling application time points as well.

Referring to FIG. 14, the application time points of the data pulses applied to the address electrodes are all different from each other. For example, the application time point of the data pulses applied to the address electrode X1, X2, X3, . . . Xm are t1, t2, t3, and so on, respectively. Because the application time points of the data pulses applied to the address electrodes are all different from each other, the effect of coupling with among the address electrodes is minimized. It is therefore possible to minimize the amount of noise. In FIG. 14, the situation in which each of the address electrode groups includes only one address electrode is described for convenience of explanation. It is, however, to be understood that the present invention can be applied to a situation where each address electrode group includes two address electrodes.

Referring back to FIG. 14, it is preferred that a difference in the application time point between successive data pulses be the same. In other words, it is preferred that the intervals between the application time points of the data pulses be substantially regular. That is, it is preferred that the intervals (t2−t1), (t3−t2), (t4−t3), (t5−t4) and (t6−t5) are all substantially the same.

It is also preferred that the intervals, e.g. (t2−t1), (t3−t2), (t4−t3), (t5−t4) and (t6−t5), all range substantially between 10 ns and 120 ns.

In addition, it is preferred that at least one of the voltage-rising time and the voltage-falling time each data pulse range substantially between 100 ns and 200 ns. Referring back to FIG. 11 for example, it is preferred that the voltage-rising times (t2−t1) and (t3−t2) and the voltage-falling times (t5−t4) and (t6−t5) all be in the range substantially between 100 ns and 200 ns. Controlling the voltage-rising and/or the voltage falling time of the data pulses allows a further weakening of the coupling of the data pulses.

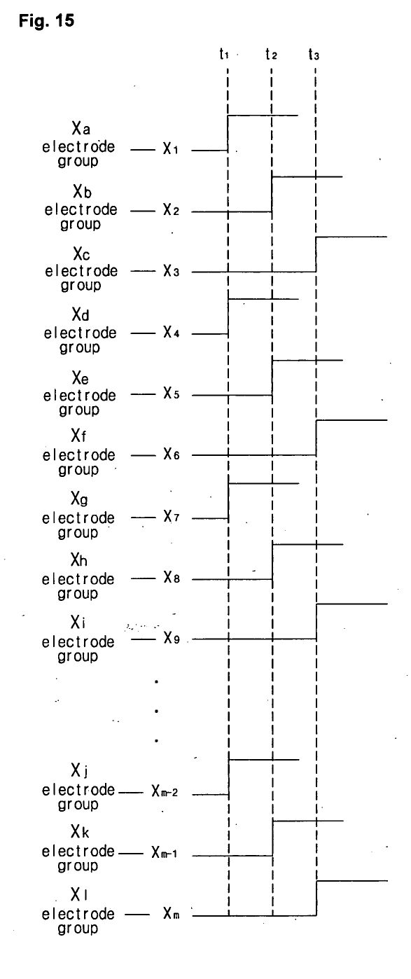

If the application time points of the data pulses applied to all address electrodes are set to be different from each other, the amount of noise generated can be minimized. However, there can be a drawback in that control can be difficult in terms of timing control of a driving circuit. In order to mitigate this drawback, the application time points of the data pulses can be set to have three or more values, i.e. it is not strictly necessary to have a different data pulse be applied to each address electrode. This method will be below described with reference to FIG. 15.

Referring to FIG. 15, the data pulses applied to the address electrodes have three or more different application time points. Also, the application time points of the data pulses are repeated periodically, and the periodical cycles thereof are the same. For example, as shown in FIG. 15, the application time points of the data pulses applied to the X1, X2 and X3 address electrodes are t1, t2 and t3, respectively. The application time points of the data pulses applied to the X4, X5 and X6 address electrodes are also t1, t2 and t3, respectively. The cycle repeats for the electrodes X5 to Xm.

Like the situation above where a unique data pulse was applied to each address electrode, it is preferred that the intervals of the application time points of the data pulses with different application time points be substantially regular. That is, the values of the aforementioned (t2−t1) and (t3−t2) are preferred to be substantially the same. It is also preferred the intervals between the application time points range substantially between 10 ns and 120 ns. It is further preferred that one or more of the voltage-rising time and the voltage-falling time of the data pulses, which are controlled to have different application time points, are set to range substantially between 100 ns and 200 ns.

As such, if application time points of data pulses are controlled in the manner described in FIG. 15, the application time point of one data pulse applied to one address electrode is different from the application time points of data pulses applied to neighboring two address electrodes. Therefore, the generation of noise is effectively reduced, and the application timing of the data pulse can be set to one of three types, facilitating easier control of the application timing.

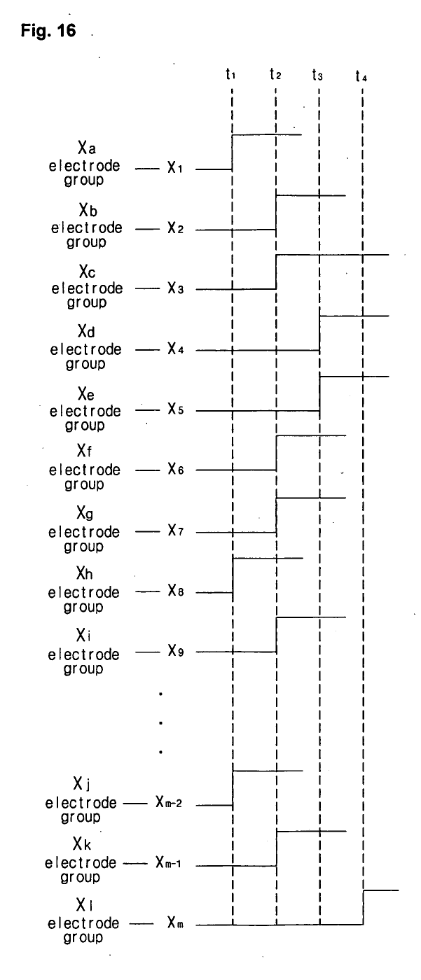

In the description of FIG. 15, for convenience of explanation, it is illustrated that each address electrode group includes only one address electrode. However, it is to be understood that the present invention can be applied to cases where each address electrode group includes two address electrodes. Also regarding FIG. 15, again for convenience of explanation, it is illustrated that the data pulses of three or more different values are repeated periodically. It is to be understood that the data pulses of three or more different values can be repeated in random manner. This method will be described with reference to FIG. 16.

Referring to FIG. 16, it is seen that the data pulses applied to the address electrodes have three or more different application time point values. Also, at least two or more of the three or more different application time points of data pulses are repeated at least twice, and one or more of the repetition cycles are different from other repetition cycles. For example, as shown in FIG. 16, the application time points of the data pulses applied to the address electrodes X1, X2, X3, X4, X5, X6, X7, X8, and X9 are t1, t2, t2, t3, t3, t2, t2, t1 and t2, respectively. That is, one or more of data pulses having three or more different application time point values are randomly repeated.

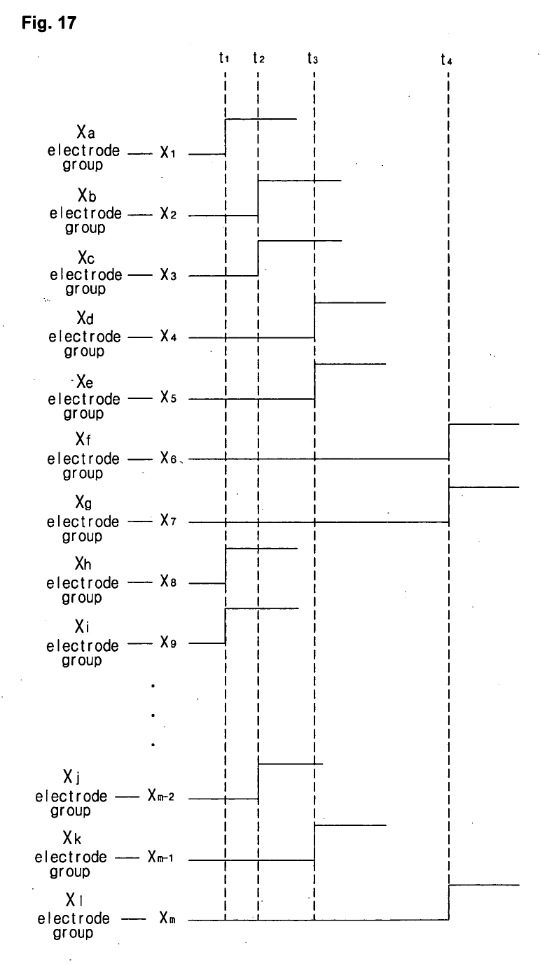

In the above description, it is indicated that the intervals between application time points of the data pulses being substantially regular is preferred. However, the intervals can be different and still be within the scope of the invention. This method will be described with reference to FIG. 17.

Referring to FIG. 17, for example, the interval (t2−t1) between the application time points of the data pulses applied to the X1 and X2 address electrodes and the interval (t3−t2) between the application time points of the data pulses applied to the X3 and X2 address electrodes are different. Furthermore, it is seen that the interval (t4−t3) (between data pulses applied to X6 and X5 electrodes) is different from the interval (t3−t2).

Regardless, it is preferred that the intervals range substantially between 10 ns and 120 ns. In other words, all the intervals (t2−t1), (t3−t2) and (t4−t3) are preferred to be somewhere between 10 and 120 ns. Also, one or more of the voltage-rising time and the voltage-falling time of all the data pulses, which are controlled to have different application time points, are preferred to range substantially between 100 ns and 200 ns.

The effectiveness of the noise reduction is enhanced when the number of channels, used to drive the data pulses to the address electrodes, included in the data drive IC is relatively large. As such, in the event that the number of channels included in one data drive IC is relatively large, e.g., 150 or more, it is more preferred to control the application time points of the data pulses of every channel included in the data drive IC. This reason will be described as follows.

As an illustration, if the number of channels included in one data drive IC is 10, then the data drive IC can be influenced by the noise generated in the ten channels. But if one data drive IC includes 150 channels, it can be influenced by noise generating in the 150 channels. In other words, the greater the number of channels included in one data drive IC, the greater the amount of noise affecting the one data drive IC. Correspondingly, the embodiments of the present invention in which the application time points of the data pulses are controlled to reduce noise become more effective when the number of channels included in one data drive IC is relatively large.

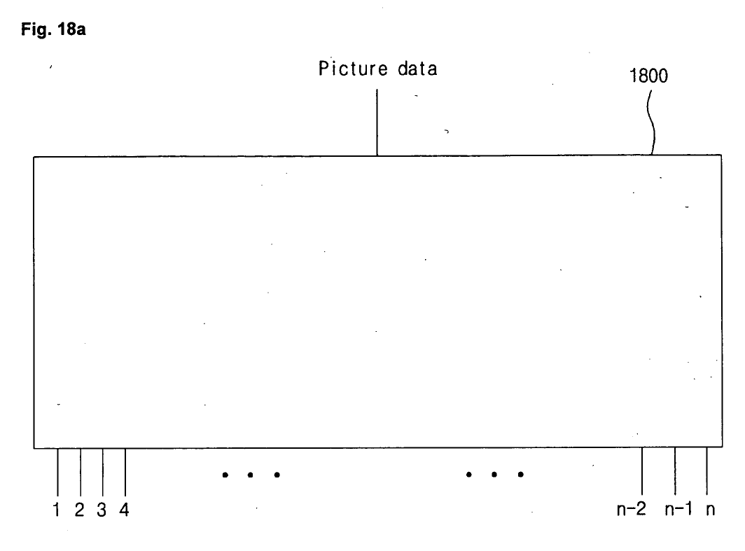

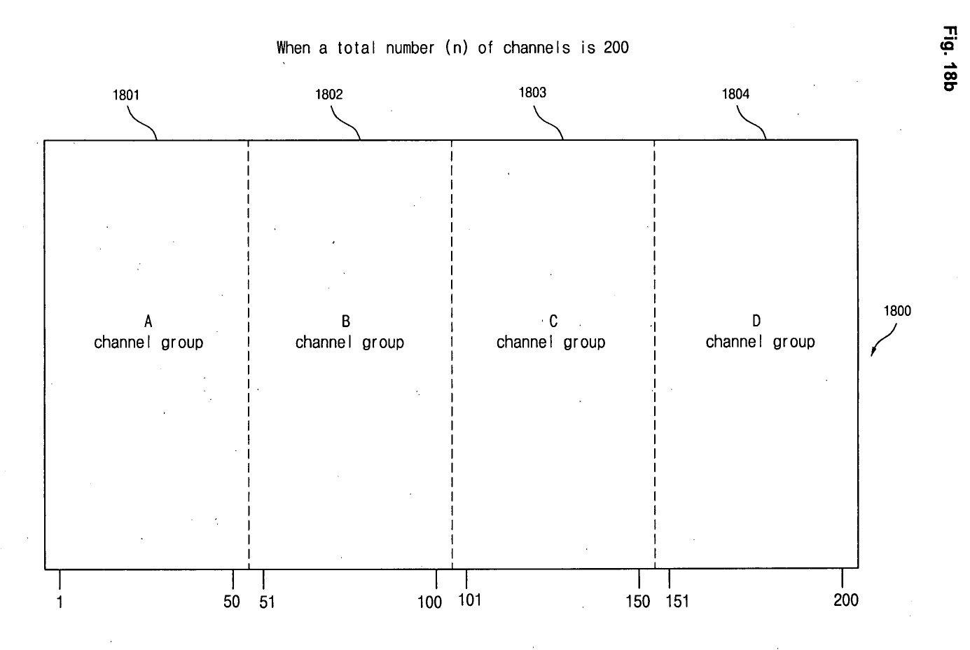

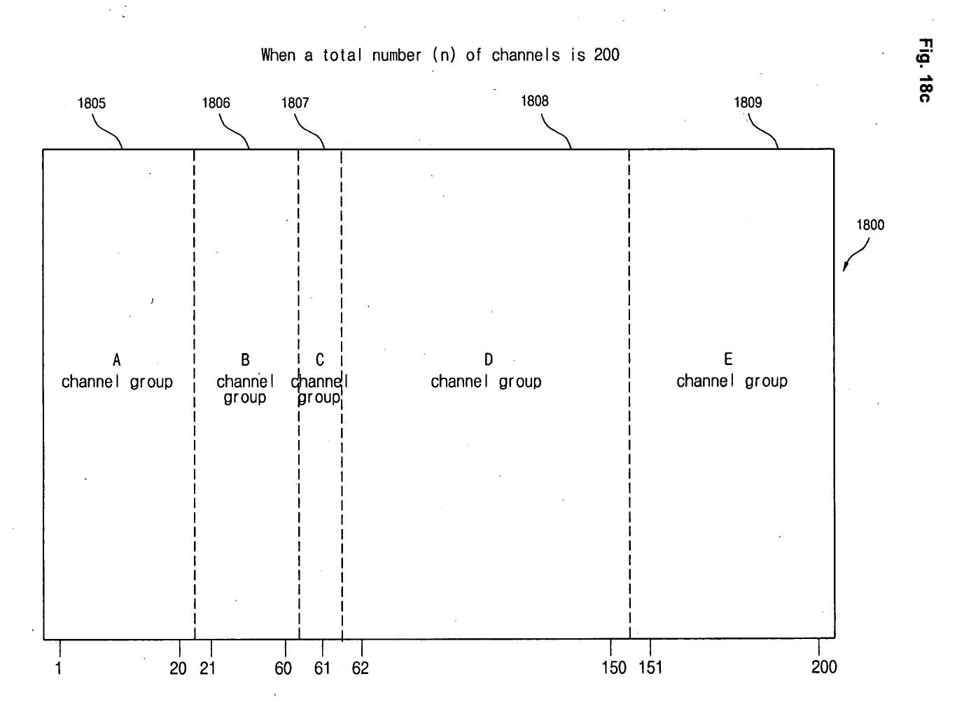

As such, where the number of channels included in one data drive IC is relatively large, it is preferred that the application time points of the data pulses applied in the address period be controlled on a channel basis. In order to help understanding of the method in which the application time points of the data pulses are controlled for every channel, an example of a data drive IC including a plurality of channels, and a method in which the plurality of channels included in the one data drive IC being divided into a plurality of channel groups with each group having one or more channels will be described with reference to FIGS. 18a to 18c.

Referring first to FIG. 18a, a data drive IC 1800 includes a plurality of channels, from channel 1 to channel n. Each channel is electrically connected to the corresponding address electrodes X one by one. This data drive IC 1800 supplies the data pulses to the address electrodes through the channels by way of a predetermined switching operation corresponding to picture data.

A method in which the plurality of the channels included in one data drive IC 1800 being divided into a plurality of channel groups with each group including one or more channels is shown in FIG. 18b. As shown, the channels are divided into an A channel group 1801, a B channel group 1802, a C channel group 1803 and a D channel group 1804 on the data drive IC 1800 of the plasma display apparatus.

In FIG. 18b, an example is shown where a total of 200 channels are formed on one data drive IC 1800. The channels are divided such that the channels 1 to 50 are defined as the A channel group 1801, channels 51 to 100 are defined as the B channel group 1802, channels 101 to 150 are defined as the C channel group 1803, and channels 151 to 200 are defined as the D channel group 1804. As such, each channel group can supply data pulses to the corresponding address electrodes with application time points being different from the data pulses supplied from other channel groups.

In this particular instance, each channel group is illustrated to include the same number of channels. That is, as shown in FIG. 18b, each channel group includes 50 channels. However, as will be demonstrated later, the number of channels can be different for the different groups.

The number of the channel groups can range from a minimum two to a total number of channels on the one data drive IC. That is, assuming that a total number of channels included in one data drive IC is “n”, the number of the channel groups can be set to 2≦N≦n. The plurality of the channel groups preferably includes the same number of channels.

As indicated above, the number of channels in the groups need not be equal. That is, one or more of the channel groups can include a different number of channels from that of other channel groups. The number of the channel groups can also be controlled. This will be described with reference to FIG. 18c.

Referring to FIG. 18c, channels the data drive IC 1800 are divided into channel groups A 1805, B 1806, C 1807, D 1808 and E 1809. One or more of the channel groups 1805, 1806, 1807, 1808 and 1809 can include a different number of channels from other channel groups. In this particular instance, all channel groups include a different number of channels. As shown in FIG. 18c to illustrate an example only, a total of 200 channels is formed on the data drive IC 1800 of the plasma display apparatus. The A channel group 1805 includes channels 1 to 20 (total of 20 channels), the B channel group 1806 includes channels 21 to 60 (total of 40), the C channel group 1807 includes channel 61 only, the D channel group 1808 includes channels 62 to 150 (total of 89), and the E channel group 1809 includes channels 151 to 200 (total of 50).

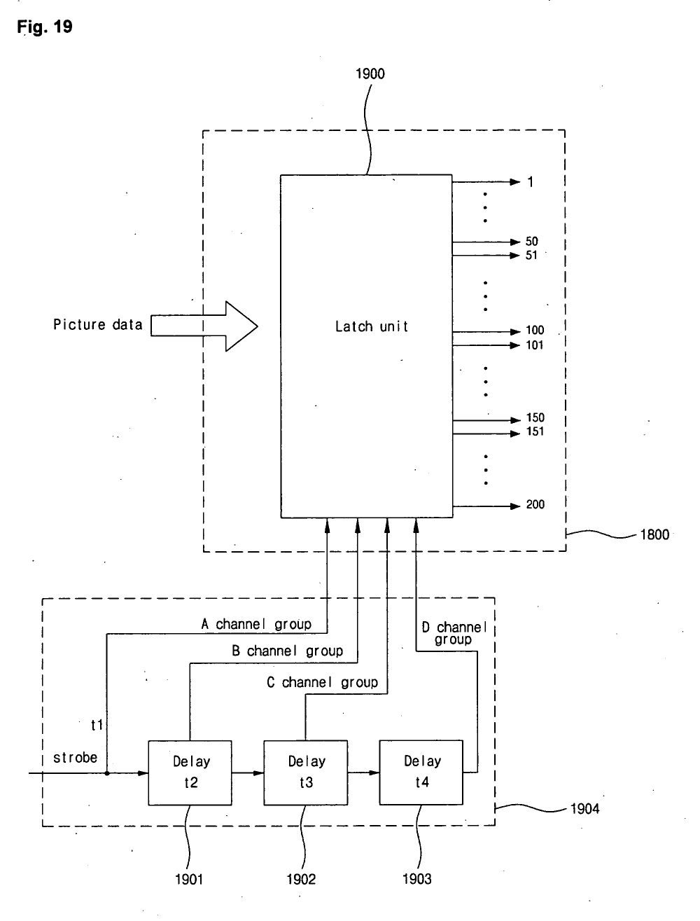

As shown in FIGS. 18b AND 18c, when the plurality of the channels are divided into the plurality of the channel groups, the application time points of data pulses applied to the address electrodes connected to neighboring channel groups are set to be different from each other. The construction of the data drive IC in the plasma display apparatus, which performs the above operation will be below described with reference to FIG. 19, which is a block diagram showing the structure of a data drive IC of a plasma display apparatus according to an embodiment of the present invention.

Referring to FIG. 19, the data drive IC 1800 includes a latch unit 1900, which is connected to the plurality of channels. The latch unit 1900 latches externally provided picture data and supplies the picture data to the plurality of the channels. The display apparatus also includes a data delay unit 1904 that delays an input signal so that data pulses with different application time points can be applied to the address electrodes connected to the neighboring channel groups connected to the latch unit 1900.

The data delay unit 1904 shown in FIG. 19 is a construction corresponding to the situation where the channels included in one data drive IC 1800 are divided into a total of four channel groups, as shown in FIG. 18b. It is to be understood that the data delay unit according to the present invention is not limited to such construction.

The latch unit 1900 latches the externally provided picture data. In other words, the latch unit 1900 causes the externally provided picture data to correspond to the address electrodes X of the plasma display panel, respectively.

Furthermore, the latch unit 1900 is connected to the plurality of the channels. Though not shown in FIG. 19, the plurality of the channels are connected to the address electrodes of the plasma display panel, and the latch unit 1900 supplies the data that are latched through the above-described channels to the address electrodes of the plasma display panel.

The aforementioned data delay unit 1904 applies one or more control signals to the latch unit 1900. In this case, the control signals cause the application time points of the data pulses that are applied from one or more of the plurality of the channel groups, each having one or more of the plurality of the channels connected to the latch unit 1900, to the address electrodes to be different from each other. For example, where channels of the one data drive IC are divided into four channel groups as shown in FIG. 18b, control signals are provided to the latch unit 1900 so that the respective channel groups can apply the data pulses to the address electrodes at different time points.

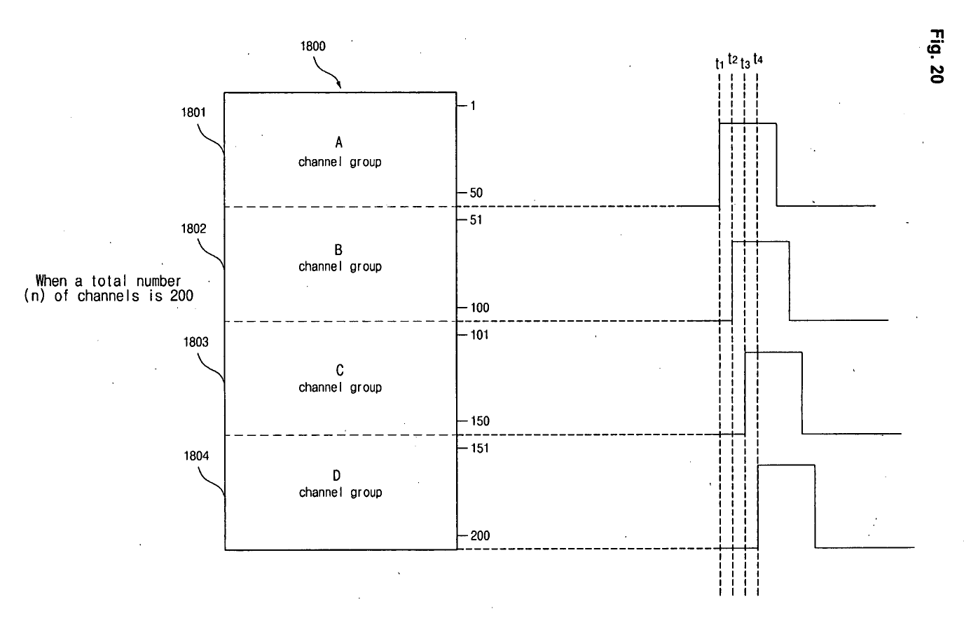

In this particular construction, the data delay unit 1904 includes time delay devices 1901, 1902 and 1903 for delaying a strobe signal applied through a strobe line. The delay introduced by each delay device is particular to the delay device and may be predetermined. The operation of the data delay unit 1904 will be described with reference to FIG. 20.

Referring to FIG. 20, for ease of explanation only, is it assumed that the channels are divided into the the A channel group 1801, the B channel group 1802, the C channel group 1803 and the D channel group 1804 as illustrated in FIG. 18b. In order to make application time points of the data pulses applied from the A channel group to the D channel group to be different, the data delay unit 1904 applies a first control signal, which controls the data pulse from the A channel group 1801 to be provided at the time point t1, to the latch unit 1900. The latch unit 1900 latches externally the input picture data and supplies the data to the address electrodes corresponding to the A channel group 1801 of FIG. 20 at the time point t1. The first control signal can be the strobe signal provided through the strobe line of the data delay unit 1904 and directly provided to the latch unit 1900.

The data delay unit 1904 applies a second control signal, which controls the data pulse applied to the B channel group 1802 to be provided at the time point t2, to the latch unit 1900. The second control signal can be the first control signal applied through the strobe line delayed a predetermined time by the time delay device 1901. That is, the time point t2 is a delay from the time point t1 by the predetermined time. At the time point t2, the latch unit 1900 latches externally the input picture data, and supplies the data to the address electrodes corresponding to the B channel group 1802 of FIG. 20 at the time point t2. Similarly, a third and fourth control signals, which can be the strobe signal delayed by the time delay devices 1902 and 1903, respectively, are provided to the latch unit 1900 to enable the data pulses with application time points t3 and t4 to be applied. The amount of delay introduced by each of the time delay devices 1902, 1903 and 1904 can be set to be different or the same for each delay device, but are preferred to be roughly similar.

In this manner, the application time points of the data pulses applied to one or more of the plurality of the channel groups can be different from those of other channel groups. For example, in the case where a total of 200 channels is formed on one data drive IC 1800 as shown in FIG. 20, the application time points of the data pulses applied to the A channel group 1801 (for channels 1-50), the B channel group 1802 (for channels 51-100), the C channel group 1803 (for channels 101-150), and the D channel group 1804 (for channels 151-200) are t1, t2, t3 and t4, respectively.

Meanwhile, unlike FIG. 20, assuming that the application time point of the data pulse applied to the A channel group 1801 is t1, the application time points of the data pulses applied to the B channel group 1802, the C channel group 1803, and the D channel group 1804 can be all set to t2 different from t1.

As noted previously, the intervals between the application time points of the data pulses applied to the respective channel groups are preferably regular and also preferably range substantially between 10 ns and 120 ns. If the intervals between the application time points of the data pulses are less than 10 ns, the generation of noise may not be sufficiently reduced. On the other hand, if the differences are longer than 120 ns, the address period becomes excessively long, which reduces the number of sustain pulses included in the sustain period of a limited length reduces. Thus, the brightness of the image may be compromised.

Also as noted above, it is preferred that one or more of the voltage-falling time and the voltage-rising time of the data pulses applied to the address electrodes through the plurality of the channel groups range substantially between 100 ns and 200 ns.

Where a plurality of the data drive ICs are included in the plasma display panel, it is preferred that data drive ICs have a same channel grouping structure. For example, assuming that ten data drive ICs are included in the plasma display apparatus, it is preferred that each data drive IC have the same A channel group structure, B channel group structure, C channel group structure, and so on. In the ten A channel groups, the application time point of the data pulses applied to all of the A channel groups is t1. Similarly, in the ten B channel groups, the application time point of the data pulses applied to all of the B channel groups is t2, and so on for the other channel groups.

Again, it is preferred that the intervals between the application time points of the data pulses be substantially regular. That is, the latch unit 1900 supplies data pulses having the same difference between the application time points to the plurality of the channels, according to the predetermined delay signals output from the data delay unit 1904.

Also, the data pulses are such that there are preferably three or more different application time point values. That is, the data delay unit 1904 applies three or more different delay signals, which cause application time points of data pulses to have three or more different values, to the latch unit 1900.

As such, by dividing the plurality of the channels included in the data drive ICs into the plurality of the channel groups where each group includes one or more channels, and making application time points of data pulses that are applied from one or more of the divided channel groups to the address electrodes be different from those of other channel groups, the amount of noise generated in the data pulses can be reduced. The reason for the noise reduction has been described in detail, for example with reference to FIG. 12. Thus, the detailed description thereof need not be repeated.

Accordingly, the address discharge occurring in the address period can be stabilized to enhance the driving capability of the plasma display panel. It is also possible to prevent electrical damage to data drive ICs.

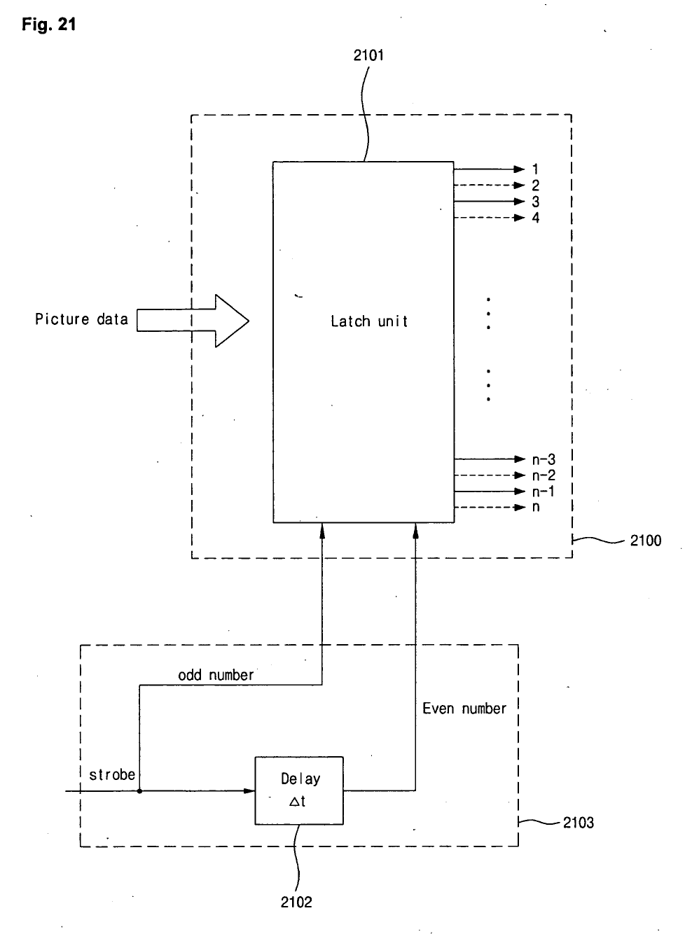

For simplicity of construction and operation, it is preferred that the plurality of channels included in one data drive IC be divided into two channel groups, and application time points of data pulses applied to the two channel groups divided thus be different from each other. The construction of the data drive IC of the plasma display apparatus according to an embodiment of the present invention will below be described with reference to FIG. 21.

Referring to FIG. 21, in the plasma display apparatus, a data drive IC 2100 includes a latch unit 2101, which is connected to a plurality of channels, latches externally provided picture data and supplies the latched picture data to the plurality of the channels. The display apparatus also includes a data delay unit 2103 that supplies control signals, which cause application time points of data pulses applied to address electrodes connected one channel group to be different from the data pulses applied to the other group. For example, the channels may be divided into an odd-numbered channel group that includes odd-numbered channels and an even-numbered channel group that include even-numbered channels.

In this instance, the construction of the data delay unit 2103 of FIG. 21 is a structure corresponding to a case where channels included in one data drive IC 2100 are divided into a total of two channel groups, i.e., the odd-numbered channel group and the even-numbered channel group, which is different from the construction of FIG. 20. The application time points of the data pulses applied to two channel groups are different from each other.

The latch unit 2101 latches the externally provided picture data. In other words, the latch unit 2101 corresponds the externally provided input picture data to the address electrodes of the plasma display panel, respectively.

Further, the latch unit 2101 is connected to the plurality of the channels. Though not shown in the drawing, the odd-numbered address electrodes of the plasma display panel are connected to the odd-numbered channel group of the data drive IC 2100. Similarly, the even-numbered address electrodes of the plasma display panel are connected to the even-numbered channel group. The latch unit 2101 supplies the data that are latched through the channels to the address electrodes of the plasma display panel.

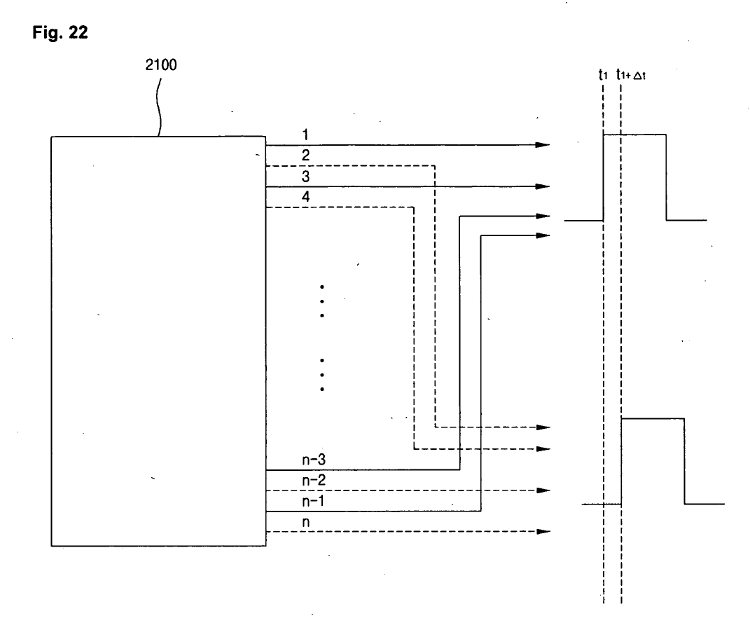

The data delay unit 2103 applies the control signals, which cause application time points of data pulses that are applied from the odd-numbered channel group to be different from that of the even-numbered channel group.

Where the channels of one data drive IC are divided into a total of two channel groups, i.e., the odd-numbered channel group and the even-numbered channel groups as shown in FIG. 21, the construction of the data delay unit 2103 can include one time delay device 2102 for delaying the strobe signal provided through the strobe line by a predetermined time Δt as shown in FIG. 21. The construction of the data delay unit 2103 will be described with reference to FIG. 22.

Referring to FIG. 22, where the channels are divided into the odd-numbered channel group and the even-numbered channel group, in order to make different application time points of data pulses applied to the odd-numbered channel group and the even-numbered channel group, the data delay unit 2103 applies the strobe signal to control the data pulses applied one of the groups, for example to the odd-numbered channel group of the data drive IC 2100, to be applied at the time point t1, to the latch unit 2101 without delay. The latch unit 2101 latches the externally provided picture data, and supplies the latched data to the address electrodes X corresponding to the odd-numbered channels of FIG. 22 at the time point t1.

Also, the data delay unit 2103 applies the strobe signal to control the data pulse applied to the other group, for example to the even-numbered channel group of the data drive IC 2100, to be applied at the time point (t1+Δt), to the latch unit 2101 with the delay of Δt. The delayed strobe signal is delayed by the time delay device 2102 by Δt.

When the data delay unit 2103 applies the control signal so that the data pulses applied to the even-numbered channel group are supplied at the time point (t1+Δt) to the latch unit 2101, the latch unit 2101 latches the externally provided picture data and supplies the latched data to the address electrodes corresponding to the even-numbered channels of FIG. 22 at the time point (t1+Δt).

In this instance, the delay Δt preferably ranges substantially between 10 ns and 120 ns. That is, it is preferred that the data delay device 2102 delays the control signal from substantially 10 ns to 120 ns. It is also preferred that one or both of the voltage-falling time and the voltage-rising time of the data pulses applied to the address electrodes through the odd-numbered channel group and the even-numbered channel group substantially range between 100 ns and 200 ns.

In FIG. 22, it is illustrated that the control signal provided to the even-numbered channel group is delayed relative to the control signal provided to the odd-numbered channel group. However, the situation can be reversed. That is, the control signal provided to the odd-numbered channel group can be delayed relative to the control signal provided to the even-numbered channel group.

As such, by dividing the plurality of the channels included in the data drive IC into the odd-numbered channel group which includes all odd-numbered channels and the even-numbered channel group which includes all even-numbered channels and making the application time points of the data pulses to the respective groups be different from each other, the amount of noise generated can be significantly reduced. As noted above, when the data pulse applied to an address electrode is different from the data pulse applied to one or both neighboring address electrodes, the equivalent capacitance is increased resulting in the reduction of noise. By dividing the channels into odd and even groups and applying the data pulses as discussed, the situation is created where different data pulses are applied between each neighboring address electrodes.

It should also be noted that the two groups need not be strictly divided into odd and even numbered groups. Another arrangement of two groups can ensure that every address electrode has at least one neighboring electrode with a different data pulse applied. In this arrangement, the first electrode X1 belongs to a first group. The second and third electrodes X2 and X3 belong to a second group. Then the electrodes X4 and X5 belong to the first group followed by electrodes X6 and X7 belonging to the second group, and so on. In other words, after the first electrode X1, the two subsequent electrodes are grouped into the other group. This is similar to the situation illustrated in FIG. 10. Of course, the end electrode should belong to a different group than the next to the end electrode.

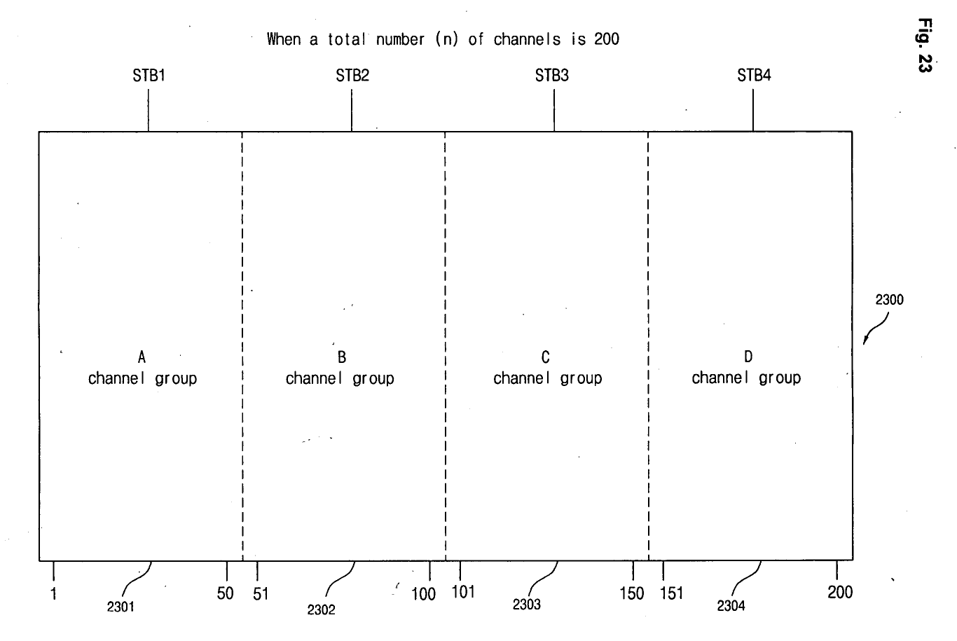

To control the application time points of the data pulses of every channel group within the one data drive IC, control signals as many as the number of different application time points of the data pulses can be provided to one data drive IC through different strobes. This will be described in more detail with reference to FIG. 23.

Referring to FIG. 23, the channels are divided into the A channel group 2301, the B channel group 2302, the C channel group 2303 and the D channel group 2304 on the data drive IC 2300 of the plasma display apparatus. This is similar to the situation described in FIG. 18b. These channel groups supply the data pulses to the address electrodes at different application time points, and the control signals are applied to the respective channel groups through different strobes so that the channel groups can supply the data pulses to the address electrodes at the different application time points.

For example, in the event that a total of 200 channels is formed on one data drive IC 2300, a first control signal that controls the application time point of a first data pulse to be t1 is applied to the A channel group 2301 (which includes channels 1-50) through a first strobe STB1, a second control signal that controls the application time point of a second data pulse to be t2 is applied to the B channel group 2302 (which includes channels 51-100) through a second strobe STB2, a third control signal that controls the application time point of a third data pulse to be t3 is applied to the C channel group 1803 (which includes channels 101-150) through a third strobe STB3, and a fourth control signal that controls the application time point of a fourth data pulse to be t4 is applied to the D channel group 1804 (which includes channels 151-200) through a fourth strobe STB4.

The line number of strobes STB for supplying the control signals can vary depending upon the number of application time points of data pulses.

As described above, according to the embodiments of the present invention, the application time points of data pulses applied to one address electrode group, where each electrode includes one or two address electrodes, are set to be different from those applied to other address electrode groups. Accordingly, generation of noise can be reduced, the driving efficiency of the plasma display panel is enhanced, and the electrical damage to the driving circuit can be prevented.

The invention being thus described, it is noted that the embodiments may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus, comprising:
a data pulse controller configured to control application of first and second data pulses, both in an address period of a frame period, to first and second address electrodes of a plasma display panel, so that the first and second data pulses are different,
wherein the first data pulse is determined to be different from the second data pulse if
a voltage-rising application time point of the first data pulse is different from a voltage-rising application time point of the second data pulse, or
a voltage-falling application time point of the first data pulse is different from a voltage-falling application time point of the second data pulse, or
both.

2. The apparatus of claim 1, wherein
an interval between the voltage-rising application time points of the first and second data pulses is greater than or substantially equal to a voltage-rising duration of the first or the second data pulse, whichever starts rising earlier, or
an interval between the voltage-falling application time points of the first and second data pulses is greater than or substantially equal to a voltage-falling duration of the first or the second data pulse, whichever starts falling earlier, or
both.

3. The apparatus of claim 1, wherein
an interval between the voltage-rising application time points of the first and second data pulses is between a predetermined minimum interval and a predetermined maximum interval, or
an interval between the voltage-falling application time points of the first and second data pulses is between the predetermined minimum interval and the predetermined maximum interval, or
both.

4. The apparatus of claim 3, wherein the predetermined minimum interval is substantially 10 ns and the predetermined maximum interval is substantially 120 ns.

5. The apparatus of claim 1, wherein
a voltage-rising time of the first data pulse ranges between a predetermined minimum transition duration and a predetermined maximum transition duration, or
a voltage-falling time of the first data pulse ranges between the predetermined minimum transition duration and the predetermined maximum transition duration, or
a voltage-rising time of the second data pulse ranges between the predetermined minimum transition duration and the predetermined maximum transition duration, or
a voltage-falling time of the second data pulse ranges between the predetermined minimum transition duration and the predetermined maximum transition duration, or
any combination of the above.

6. The apparatus of claim 5, wherein the predetermined minimum transition duration is substantially 100 ns and the predetermined maximum transition duration is substantially 200 ns,

7. The apparatus of claim 1, wherein the data pulse controller is configured to control application of a plurality of data pulses including the first and second data pulses in the address period to all address electrodes of the plasma display panel such that for each address electrode, a data pulse applied to the each address electrode is different from a data pulse applied to at least one address electrode neighboring the each address electrode.

8. The apparatus of claim 7, wherein the data pulse applied to the each address electrode is different from data pulses applied to all address electrodes neighboring the each address electrode.

9. The apparatus of claim 8, wherein the first and second data pulses are alternately applied to all address electrodes.

10. The apparatus of claim 8, wherein a unique data pulse is applied to each address electrode.

11. The apparatus of claim 7, wherein
either the first or the second data pulse is applied to each address electrode, and
neither the first nor the second data pulse is applied to more than any two consecutive address electrodes.

12. The apparatus of claim 7, wherein
intervals between the voltage-rising application time points of the plurality of data pulses is substantially regular, or
intervals between the voltage-falling application time points of the plurality of data pulses is substantially regular, or
both.

13. The apparatus of claim 7, wherein the data pulse controller further includes a data delay unit, wherein the data delay unit comprises one or more delay devices, each delay device configured to control output of one of the plurality of data pulses in response to a strobe signal applied to the data delay unit.

14. The apparatus of claim 13, wherein when the data delay device includes two or more delay devices, the delay devices are connected serially such that an output of a previous delay device is provided to an input of a subsequent delay device.

15. The apparatus of claim 13, wherein when the strobe signal is utilized as a control signal to control output of at least one of the plurality of data pulses.

16. The apparatus of claim 7, wherein
the plurality of address electrodes are grouped into a plurality of address groups, each address group including at least one address electrode and a data pulse being applied to all address electrodes of the address group, and
the data pulse controller is configured to control application of the plurality of data pulses in an address period to all address groups such that for each address group, a data pulse applied to the address group is different from a data pulse applied to a neighboring address group.

17. The apparatus of claim 7, further comprising a data drive IC,
wherein the data drive IC includes a plurality of channels providing the plurality of data pulses to the corresponding plurality of address electrodes,
wherein the plurality of channels are divided into a plurality of channel groups with each channel group including one or two electrodes, and
wherein the data pulse controller controls the plurality of channels such that data pulses provided by channels of each channel group is different from data pulses provided by channels of channel groups neighboring the channel group.

18. The apparatus of claim 7, wherein the data pulse controller controls the plurality of channels such that data pulses provided by channels of each channel group are all substantially the same within the each channel group.

19. The apparatus of claim 7, further comprising a data drive IC,
wherein a plurality of channels providing the plurality of data pulses to the corresponding plurality of address electrodes,
wherein the plurality of channels are divided into an odd-number channel group that includes all odd-numbered channels and an even-number channel group that includes all even-numbered channels, and
wherein the data pulse controller controls the plurality of channels such that data pulses provided by channels of the odd-number channel group are all substantially the same with each other, the data pulse controller controls the plurality of channels such that data pulses provided by channels of the even-number channel group are all substantially the same with each other, and the data pulses of the odd-number channel group are different than the data pulses of the even-number channel group.

20. A method to drive a plasma display panel, comprising:
controlling application of first and second data pulses, both in an address period of a frame period, to first and second address electrodes of the plasma display panel that are neighbors of each other, respectively, so that the first and second data pulses are different,
wherein the first data pulse is determined to be different from the second data pulse if
a voltage-rising application time point of the first data pulse is different from a voltage-rising application time point of the second data pulse, or
a voltage-falling application time point of the first data pulse is different from a voltage-falling application time point of the second data pulse, or
both.
